(19) United States
(12) Patent Application Publication
(10) Pub. No.: US 2024/0286443 A1
(43) Pub. Date: Aug. 29, 2024

(54) WHEEL-HOLDER, TIRE CHANGER APPARATUS USING SAID WHEEL-HOLDER AND ADJUSTMENT PROCESS OF SAID WHEEL-HOLDER

(71) Applicant: VEHICLE SERVICE GROUP ITALY S.R.L., Ostellato (IT)

(72) Inventors: Paolo Signorelli, Rio Saliceto (IT); Gianfranco Pellacani, Correggio (IT); Stefano Casaletti, Novellara (IT)

(73) Assignee: VEHICLE SERVICE GROUP ITALY S.R.L., Ostellato, FE (IT)

(21) Appl. No.: 18/586,962

(22) Filed: Feb. 26, 2024

(30) Foreign Application Priority Data
Feb. 24, 2023 (IT) 102023000003243

(51) Int. Cl. B60C 25/05

(52) U.S. Cl. CPC B60C 25/0536

(57) ABSTRACT

The present invention concerns a wheel-holder including: a support base, a shaft slidingly movable with respect to the support base and having a plurality of stops, a support plate carried by the shaft and configured to receive the rim of a wheel, a block carried by the support base and configured to engage a stop for locking the shaft in an operating position, preventing the relative sliding between support base and shaft. The block includes an insert movable with respect to the shaft, a maneuvering element active on the insert and configurable between a thrust position and a release position. The block includes a pusher which, in the release position of the maneuvering element, thrusts on the insert to maintain it in engagement with the stop.

### CLAIM OF PRIORITY

This application claims priority under 35 USC § 119(a) to Italian Patent Application no. 102023000003243, filed on Feb. 24, 2023, the entire content of which is hereby incorporated by reference.

### TECHNICAL FIELD

The present invention refers to a wheel-holder for vehicle wheels, as well as a tire changer apparatus using said wheel-holder. The present invention also concerns an adjustment process of said wheel-holder. The present invention may find application in the field of construction of equipment for the assistance and repair of vehicles. The present invention may also find application in the automotive field for tire replacement or for the first mounting of a tire on a car rim. However, the present invention may generally be used in all fields requiring the mounting//demounting of wheel tires for various types of vehicles, including trucks, agricultural vehicles and motorbikes.

### BACKGROUND

The known tire changers are provided with a wheel-holder, configured to engage a wheel of a vehicle, and a plurality of tools configured to operate on the wheel for mounting/demounting the tire. The wheel-holder comprises a shaft emerging from a base of the tire changer along a vertical axis and a plate, opposed to the base, configured to receive the rim of the wheel in support. The wheel is blocked against the plate by means of appropriate cones which, on the one hand, thrusts on the hub of the wheel and, on the other hand, constrain themselves to the wheel-holder. The wheel-holder is rotatably mounted on the base to allow the rotation of the wheel around a vertical axis.

The wheel-holder comprises a sleeve inside which the shaft carrying the plate slides. The shaft is height adjustable to move the plate away from and approaching the base of the tire changer. In this way, the operator may arrange the plate at the desired height to facilitate the positioning and unloading operations of the plate. Once the desired height has been determined, the shaft is locked in place by means of cylindrical pins inserted into appropriate seats on the shaft and on the sleeve. Examples of known wheel-holders are described in the following patent applications: EP4067121A1, EP3865321A1, EP3434500A1, EP3357712A1.

The Applicant noted that the known tire changers are not free of drawbacks and may therefore be improved in several respects. The Applicant pointed out that the known wheel-holders have a design that cannot guarantee a safe and quick adjustment of the height of the plate; moreover, due to the complex structure, they require the presence of two operators to safely adjust the height of the plate—a condition that negatively affects the overall productivity of the tire changer apparatus.

### SUMMARY

The purpose of the present invention is to overcome at least one of the drawbacks and/or limitations of the preceding solutions.

An object of the present invention is to provide a wheel-holder that is easily and quickly adjustable in its operating positions, in particular safely adjustable by a single operator. It is also an object of the present invention to provide a wheel-holder having a simple and compact structure, which may be realized with low costs, but which is, at the same time, structurally robust, capable of effectively locking a wheel of a vehicle, and minimizing undesirable oscillations.

It is furthermore an object of the present invention to provide a tire changer apparatus capable of efficiently performing the mounting/demounting operations of a tire from a rim of a wheel. It is also an object of the present invention to provide a tire changer apparatus flexible in use, and capable of ensuring the effective and rapid mounting/demounting of a wide range of tires. Finally, it is an object of the present invention to provide a tire changer apparatus capable of operating safely and in particular of achieving the objective of mounting/dismounting a tire from a rim without damaging the latter or the tools of the apparatus itself. These purposes and others, which will appear more clearly from the following description, are substantially achieved by a wheel-holder and a relative tire changer apparatus according to one or more of the attached claims.

In a 1st aspect, a wheel-holder (3) for a wheel of a vehicle is provided, said wheel-holder (3) comprising:
a support base (30) having a seat (30a),
a shaft (31) housed at least partially in the seat (30a), wherein the shaft is slidingly movable with respect to the support base (30) between a plurality of operating positions, wherein the shaft (31) comprises a plurality of stops (32) defined on an outer lateral surface of said shaft (31),
a support plate (3b) configured to receive a rim of a wheel, wherein the support plate is carried by at least one of the shaft (31) and the support base,
a block (10) carried by the support base (30) and configured to engage at least one stop (32) to lock the shaft (31) in an operating position, preventing the relative sliding between support base (30) and shaft (31), wherein the block (10) comprises:
at least an insert (11) movable with respect to the shaft (31),
a maneuvering element (12) active on the insert (11) and configurable between:
   a thrust position where the maneuvering element (12) thrusts on at least a part of the insert (11) to allow the insert to be engaged with at least one stop (32) to lock the relative sliding between support base (30) and shaft (31),
   a release position where the maneuvering element (12) is configured to allow the movement of the insert (11), optionally away, with respect to the shaft (31).

In an aspect 1b is, according to the preceding aspect, the block (10) comprises at least one pusher (20) which, in the release position of the maneuvering element (12), thrusts on at least a part of said insert (11) to maintain said part of said insert (11) in engagement with at least one stop (32) of the shaft (31).

In a 2nd aspect, according to any one of the preceding aspects, the shaft (31) extends between a first and a second end (31a, 31b) along an extension trajectory (T). In a 3rd aspect, according to the preceding aspect, the plurality of stops (32) comprises at least one set of stops aligned along a direction substantially parallel to the extension trajectory (T) of the shaft itself. In a 4th aspect, according to the preceding aspect, the plurality of stops (32) comprises:
a first set of stops aligned along a first direction substantially parallel to the extension trajectory (T) of the shaft itself,
a second set of stops spaced apart from the first set of stops and aligned along a second direction substantially parallel to the extension trajectory (T) of the shaft itself.

In a 5th aspect, according to the preceding aspect, the first and the second set of stops are opposed. In a 6th aspect, according to the 4th or 5th aspect, the first and the second set of stops are one symmetrical to the other in relation to a centerline plane of the shaft (31). In a 7th aspect, according to any one of the aspects from the 4th to the 6th, the first and the second set of stops are identical. In an 8th aspect, according to any one of the aspects from the 4th to the 7th, the stops of the first and second set of stops are identical, optionally are equal in shape and size. In a 9th aspect, according to any one of the aspects from the 4th to the 8th, the first set of stops has the same number of stops of the second set of stops.

In a 10th aspect, according to any one of the preceding aspects, each stop (32) is defined by a cavity. In an 11th aspect, according to the preceding aspect, the cavity of each stop (32) is blind. In a 12th aspect, according to the 10th or 11th aspect, the cavity of each stop has, in section according to a plane parallel to the extension trajectory (T), a substantially “V”-shaped outline. In a 13th aspect, according to any one of the aspects from the 10th to the 12th, the cavity of each stop (12) has substantially a cone-shape, optionally a straight circular cone, or truncated cone-shape.

In a 14th aspect, according to any one of the preceding aspects, the shaft (31) has a number of stops (32) equal to or higher than 2, optionally between 3 and 12, even more optionally between 3 and 9. In a 15th aspect, according to any one of the aspects from the 4th to the 14th, the first set of stops has a number of stops higher than 2, optionally between 2 and 5. In a 16th aspect, according to any one of the aspects from the 4th to the 15th, the second set of stops has a number of stops higher than 2, optionally between 2 and 5.

In an aspect 16bis, according to any one of the aspects from the 4th to the 6th, or according to any one of the aspects from the 9th to the 11th, or according to any one of the aspects from the 14th to the 16th, the stops (32) of the first set are different from the stops of the second set. In an aspect 16ter, according to any one of the aspects from the 9th to the 11^{th}, or according to any one of the aspects from the 14th to the 16th, or according to the aspect 16bis, the cavity of at least a part of the stops (32) has, in section according to a plane parallel to the extension trajectory (T), a substantially “V”-shaped outline.

In an aspect 16quater, according to any one of the aspects from the 9th to the 11th, or according to any one of the aspects from the 14th to the 16th, or according to the aspect 16bis or 16ter, the cavity of at least a part of said stops (12) has a substantially oblique or truncated cone shape. In an aspect 16quinquies, according to any one of the aspects from the 9th to the 11th, or according to any one of the aspects from the 14th to the 16th, or according to the aspect 16bis or 16ter or 16quater, wherein:
the cavity of the stops (12) of the first set has substantially a straight circular cone shape, or truncated straight cone-shape,
the cavity of the stops (12) of the second set has a substantially oblique or truncated cone shape.

In a 17th aspect, according to any one of the preceding aspects, the insert (11) is movable with respect to the support base (30) along a direction transversal to the extension trajectory (T). In an 18th aspect, according to any one of the preceding aspects, the insert (11) is movable along a direction orthogonal to the extension trajectory (T) of the shaft (31).

In a 19th aspect, according to any one of the preceding aspects, the insert (11) comprises at least one head body (11a) which extends between:
a front surface (11a′) configured to engage at least one stop (32) of the shaft (31),
a rear surface (11a″) opposed to the front surface, optionally wherein the insert (11) is configured to receive the pusher (20) in correspondence of the rear surface (11a″).

In a 20th aspect, according to the preceding aspect, the front surface (11a′) is at least partially countershaped to the stops (32) of the shaft (31). In a 21st aspect, according to the 19th or 20th aspect, the front surface (11a′) of the head body has, in section according to a plane parallel to the extension trajectory (T), a substantially “V”-shaped outline. In a 22nd aspect, according to anyone of the aspects from the 19th to the 21st, the front surface (11a′) of the head body has a cone-shape, optionally a straight circular cone, or truncated cone-shape.

In a 23rd aspect, according to any one of the aspects from the 19th to the 22nd, the pusher (20) directly contacts with the rear surface (11a″) of the head body (11a) to force, in the release position of the maneuvering element (12), the engagement of the insert (11) with at least one stop (32) of the shaft (31).

In a 24th aspect, according to anyone of the aspects from the 19th to the 23rd, the pusher (20) is configured to maintain normally the head body (11a) in engagement with at least one stop (32) of the shaft (31).

In a 25th aspect, according to any one of the preceding aspects, the shaft (31), upon action by the operator and in the release position of the maneuvering element (12), is configured to generate on the insert (11) a force suitable for counteracting the thrust action of the pusher (20) in order to allow, in the release position of the maneuvering element (12), the relative movement of the insert (11) with respect to the shaft (31) to allow the disengagement of said insert (11) with the stop (32).

In a 26th aspect, according to any one of the aspects from the 19th to the 25th, the front surface (11a′) of the insert (11) has at least one contact portion with the stop (32) inclined with respect to the extension trajectory (T) of the shaft (31). In a 26bis aspect, according to the preceding aspect, the inclined contact portion of the front surface (11a′) is configured to generate, at least in the release position of the maneuvering element (12) and following a thrust action on the shaft (31) having direction parallel to the extension trajectory (T), a thrust force opposite to a thrust force generated by the pusher (20).

In a 27th aspect, according to any one of the aspects from the 19th to the 26th or 26bis, the insert (11) comprises a bottom body (11b) facing the head body (11a). In a 28th aspect, according to any one of the aspects from the 19th to the 27th, the bottom body (11b) is aligned to the head body (11a) along a direction (B) transversal to an extension trajectory of the shaft (31). In a 29th aspect, according to the preceding aspect, the bottom body (11b) is aligned to the head body (11a) along a direction (B) transversal, optionally orthogonal, to the extension trajectory (T) of the shaft (31).

In a 30th aspect, according to any one of the aspects from the 27th to the 29th, the pusher (20) is interposed between the head body (11a) and the bottom body (11b). In a 31st aspect, according to any one of the aspects from the 27th to the 30th, the bottom body (11b) directly contacts the maneuvering element (12).

In a 32nd aspect, according to any one of the aspects from the 27th to the 31st, the maneuvering element (12), in the release position and in the thrust position, directly contacts the bottom body (11b).

In a 33rd aspect, according to any one of the aspects from the 27th to the 32nd, the bottom body (11b) is interposed between the head body (11a) and the maneuvering element (12). In a 34th aspect, according to any one of the aspects from the 27th to the 33rd, the bottom body (11b), in the thrust position of the maneuvering element (12), directly contacts the head body (11a).

In a 35th aspect, according to any one of the aspects from the 19th to the 34th, the head body (11a) has, in correspondence of the rear surface (11a″), a blind seat (110) suitable for receiving the pusher (20). In a 36th aspect, according to the preceding aspect, the seat (110) of the head body (11a) extends from the rear surface (11a″) towards the front surface (11a′). In a 37th aspect, according to any one of the aspects from the 27th to the 36th, the bottom body (11b) extends respectively between:
a front surface (11b′) configured to directly contact the head body (11a) of the insert (11),
a rear surface (11b″) opposed to the front surface (11b′) of said bottom body.

In a 38th aspect, according to the preceding aspect, the rear surface (11b″) of the bottom body (11b) directly contacts the maneuvering element (12). In a 39th aspect, according to the 37th or 38th aspect, the bottom body (11b) has, in correspondence of its front surface (11b′), a respective blind seat (120) suitable for receiving the pusher (20). In a 40th aspect, according to the preceding aspect, the seat (120) of the bottom body (11b) extends from the front surface (11b′) of the bottom body (11b) in direction of the rear surface (11b″) of the same bottom body (11b). In a 41st aspect, according to the 39th or 40th aspect, the seat (120) of the bottom body (11b) is facing the respective seat (110) of the head body (11a).

In a 42nd aspect, according to any one of the aspects from the 39th to the 41st, the seat (110) of the head body (11a) and the respective seat (120) of the bottom body (11b) substantially define a single cavity where it is housed the pusher (20).

In a 43rd aspect, according to any one of the aspects from the 27th to the 42nd, the bottom body (11b) is at least partially housed in the seat (110) of the head body (11a). In a 44th aspect, according to any one of the aspects from the 27th to the 43rd, the bottom body (11b) is slidingly movable at least partially in the seat (110) of the head body (11a). In an aspect 44bis, according to any one of the aspects from the 19th to the 44th, the head body (11a) is configured to cooperate with a plurality of stops (32) aligned along a single direction parallel to an extension direction of the shaft, optionally parallel to the extension trajectory (T).

In a 45th aspect, according to any one of the aspects from the 1st to the 44th or to the aspect 44bis, the pusher (20) acts directly on the head body (11a) of the insert (11). In a 46th aspect, according to any one of the aspects from the 1st to the 26th or the 27th aspect, the block (10) comprises a support (130) engaged to the support base (30), wherein the pusher (20) is interposed between the support (130) and the head body (11a).

In a 47th aspect, according to any one of the aspects from the 1st to the 26th or 26bis or according to the 45th or 46th aspect, the insert (11) comprises also an auxiliary body (11c) distinct and spaced apart from the head body (11a). In a 48th aspect, according to the preceding aspect, the auxiliary body (11c) is arranged substantially on a same plane upon which it is arranged the head body (11a), wherein said plane is orthogonal to the extension trajectory (T) of the shaft (31). In a 49th aspect, according to the 47th or 48th aspect, the auxiliary body (11c) is angularly offset with respect to the head body (11a) with respect to an axis parallel to an extension direction of the shaft, optionally parallel to the extension trajectory (T).

In a 50th aspect, according to any one of the aspects from the 47th to the 49th, the auxiliary body (11c) is opposed to the head body (11a) with respect to the shaft (31). In a 51st aspect, according to any one of the aspects from the 47th to the 50th aspect, the pusher (20) exclusively direct contacts the head body (11a) of the insert (11) while the maneuvering element (12) directly thrusts on the auxiliary body (11c) only.

In a 52nd aspect, according to any one of the aspects from the 47th to the 51st, the head body (11a) is configured to engage the stops of the second set of stops while the auxiliary body (11c) is configured to engage the stops of the first set of stops. In a 53rd aspect, according to any one of the aspects from the 47th to the 52nd, the auxiliary body (11c) extends between:
a respective front surface (11c′) configured to engage at least one stop (32) of the shaft (31),
a respective rear surface (11c″) opposed to said front surface (11c′) and suitable for receiving in contact the maneuvering element (12).

In a 54th aspect, according to the preceding aspect, the front surface (11c′) of the auxiliary body (11c) is at least partially countershaped to the stops (32) of the shaft (31). In a 55th aspect, according to the 53rd or 54th aspect, the front surface (11c′) of the auxiliary body has, in section according to a plane parallel to the extension trajectory (T), a substantially “V”-shaped outline. In a 56th aspect, according to any one of the aspects from the 53rd to the 55th, the front surface (11c′) of the auxiliary body (11c) has a cone-shape, optionally a straight circular cone, or truncated cone-shape.

In a 57th aspect, according to any one of the aspects from the 53rd to the 56th, the maneuvering element (12) is only active on the auxiliary body (11c) of the insert (11) and configurable between:
a thrust position where the maneuvering element (12) thrusts on said auxiliary body (11c) of the insert (11) only to allow it to be engaged with at least one stop (32) to lock the relative sliding between support base (30) and shaft (31),
a release position where the maneuvering element (12) is configured to allow the auxiliary body (11c) of the insert (11) to move away from the shaft (31), optionally away from the head body (11a).

In a 58th aspect, according to the preceding aspect, the pusher (20) during the release position during which the auxiliary body (11c) is movable away of the shaft (31), thrusts on the head body (11a) to force its engagement with a stop (32) of the shaft. In a 59th aspect, according to any one of the aspects from the 53rd to the 58th, the front surface (11c′) of the auxiliary body (11c) is identical in shape, optionally in shape and size, to the front surface (11a′) of the head body (11a).

In a 59bis aspect, according to any one of the preceding aspects, the insert (11) comprises:
at least one first head body according to any one of the aspects from the 19th to the 45th, said first head body being configured to engage the stops of the first set,
a bottom body (11b) according to any one of the aspects from the 27th to the 45th facing the first head body,
a second head body according to any one of the aspects from the 19th to the 26th, said second head body being distinct and spaced apart from the first head body and configured to engage the stops of the second set.

In a 59ter aspect, according to the preceding aspect, the at least one pusher of the block (10) comprises:
a first pusher (20′) interposed between the first head body and the bottom body (11b),
a second pusher (20″) thrusting on the rear surface (11a″) of the second head body.

In a 59quater aspect, according to the preceding aspect, the block (10) comprises a support (130) engaged to the support base (30), wherein the second pusher (20″) is interposed between the support (130) and the second head body.

In a 59quinquies aspect, according to any one from the 59bis aspect to the 59quater aspect, the second head body is arranged substantially on a same plane upon which it is arranged the first head body, wherein said plane is orthogonal to the extension trajectory (T) of the shaft (31). In a 59sexies aspect, according to any one from the 59bis aspect to the 59quinqies aspect, the second head body is angularly offset with respect to the first head body with respect to an axis parallel to an extension direction of the shaft, optionally parallel to the extension trajectory (T). In a 59septies aspect, according to any one from the 59bis aspect to the 59sexies aspect, the second head body is opposed to the head body with respect to the shaft. In a 59octies aspect, according to any one from the 59bis aspect to the 59septies aspect, the maneuvering element (12) only directly thrusts on the bottom body (11b).

In a 60th aspect, according to any one of the preceding aspects, the support base (30) comprises a lateral wall delimiting the seat (30a). In a 61st aspect, according to the preceding aspect, the support base (30) extends between a lower end (30′) and an upper end (30″) along an extension direction (A). In a 62nd aspect, according to the preceding aspect, the seat (30a) of the support base (30) extends from the upper end (30″) to the lower end (30′) along the extension direction (A) of the same support base (30).

In a 63rd aspect, according to any one of the aspects from the 60th to the 62nd, the support base (30) comprises a hollow sleeve. In a 64th aspect, according to the preceding aspect, the lateral wall of the hollow sleeve has an outer surface which, in section, has a circular outline.

In a 65th aspect, according to any one of the aspects from the 60th to the 64th, the support base (30) comprises at least an opening (33) passing through the lateral wall, wherein the insert (11) is engaged at least partially in the through opening (33) of the support base (30). In a 66th aspect, according to the preceding aspect, the head body (11a) of the insert (11) is slidingly movable in the opening (33) of the lateral wall of the support base (30).

In a 67th aspect, according to the 65th or 66th aspect, the opening (33) is placed at the upper end (30″) of the support base (30). In a 68th aspect, according to any one of the aspects from the 65th to the 67th, the block (10) is placed at the through opening (33).

In a 69th aspect, according to any one of the aspects from the 65th to the 68th, the through opening (33) is at least partially countershaped to an outer surface of the head body (11a) of the insert (11). In a 70th aspect, according to any one of the aspects from the 65th to the 69th, the through opening comprises at least one hole, optionally circular. In a 71st aspect, according to any one of the aspects from the 65th to the 70th, the support base (30) comprises at least one single opening (33) passing through the lateral wall.

In a 72nd aspect, according to any one of the aspects from the 65th to the 70th, the support base (30) comprises:
a first through opening (33′) passing through the lateral wall and inside which the head body (11a) of the insert (11), optionally the first head body, is slidingly movable,
a second through opening (33″) passing through the lateral wall and inside which the auxiliary body (11c) of the insert (11) or optionally the second head body is slidingly movable.

In a 73rd aspect, according to the preceding aspect, the first and the second through opening are opposed the one to the other. In a 74th aspect, according to the 72nd or 73rd aspect, the first and the second through opening (33′, 33″) are both arranged in correspondence of the upper end (30″) of the support base (30). In a 75th aspect, according to any one of the aspects from the 72nd to the 74th, the first through opening (33′) comprises a hole, optionally with circular section. In a 76th aspect, according to any one of the aspects from the 72nd to the 75th, the second through opening (33″) comprises a hole, optionally with circular section.

In a 77th aspect, according to any one of the preceding aspects, the shaft (31) is at least partially countershaped to the seat (30a). In a 78th aspect, according to any one of the preceding aspects, the shaft (31) and the support base (30) are constrained by means of a skid-type constraint. In a 79th aspect, according to any one of the preceding aspects, the shaft (31) is movable only slidingly relatively to the support base (30). In an 80th aspect, according to any one of the preceding aspects, the seat (30a) of the support base (30) has, in section according to a plane orthogonal to the extension trajectory (T) of the shaft, a shape having at least two axes of symmetry. In an 81st aspect, according to any one of the preceding aspects, the seat (30a) of the support base (30) has, in section according to a plane orthogonal to the extension trajectory(T) of the shaft, a shape having a number of axes of symmetry higher than 1, optionally a number of axes of symmetry between 2 and 8. In an 82nd aspect, according to any one of the preceding aspects, the seat (30a) of the support base (30) has, in section according to a plane orthogonal to the extension trajectory (T) of the shaft, a polygonal shape, optionally in the shape of a square or hexagon.

In an 83rd aspect, according to any one of the preceding aspects, the at least one pusher (20) comprises an elastic return element. In an 84th aspect, according to any one of the preceding aspects, the pusher (20) comprises a spring, optionally a compression spring. In an 85th aspect, according to the 83rd or 84th aspect, the spring is configured to generate a thrust force on the head body (11a) suitable for forcing the engagement of said thrust body (11a) with at least one stop (32) of the shaft (31).

In an 86th aspect, according to any one of the aspects from the 2nd to the 85th the second end (31b) of the shaft (31), in the various operating positions, is placed respectively at different distances from the support base (30). In an 87th aspect, according to the preceding aspect the support plate (3b) is placed at the second end (31b) of the shaft (31).

In an 88th aspect, according to the 86th or 87th aspect, the shaft (31) is movable with respect to the support base (30) at least between a first and a second operating position, wherein:
in the first operating position, the first end (31a) of the shaft is housed in the seat (30a) of the support base (30) while the second end (31b) is placed outside of said seat (30a) at a first distance from said support base (30),
in the second operating position, the first end (31a) of the shaft is housed in the seat (30a) of the support base (30) while the second end (31b) is placed outside of said seat (30a) at a second distance from said support base (30) greater than said first distance.

In an 89th aspect, according to any one of the preceding aspects, the shaft (31) has, in section according to a plane orthogonal to the extension trajectory(T) of the shaft, a polygonal shape, optionally square or hexagonal. In a 90th aspect, according to any one of the preceding aspects, the shaft (31) is countershaped to the seat (30a) of the support base (30). In a 91st aspect, according to any one of the preceding aspects, the maneuvering element (12) comprises:
a lever (12a),
a thrust head (12b) connected to the lever and configured to thrust on at least a part of the insert (11).

In a 92nd aspect, according to the preceding aspect, the thrust head (12b) directly contacts the bottom body (11b) of the insert. In a 93rd aspect, according to the 91st or 92nd aspect, the thrust head (12b), in the thrust position of the maneuvering element (12), is configured to directly thrust on the bottom body (11b) to allow the engagement of the head body (11a) with at least one stop (32) of the shaft (31).

In a 94th aspect, according to the 91st aspect, the thrust head (12b) directly contacts the auxiliary body (11c). In a 95th aspect, according to the preceding aspect, the thrust head (12b), in the thrust position of the maneuvering element (12), is configured to directly thrust on the auxiliary body (11c) to allow it to be engaged with at least one stop (32) of the shaft (31).

In a 96th aspect, according to any one of the aspects from the 91st to the 95th, the thrust head (12b) comprises an eccentric configured to rotate relatively with respect to the insert (11). In a 97th aspect, according to the preceding aspect, the thrust head comprises at least one cam. In a 98th aspect, according to the 96th or 97th aspect, the thrust head (12b) is configured to rotate around an axis transversal to a direction of movement of the insert (11). In a 99th aspect, according to any one of the aspects from the 96th to the 98th, the thrust head (12b) is configured to rotate around an axis (C) substantially parallel to the extension trajectory (T) of the shaft (31). In a 100th aspect, according to the preceding aspect, the axis of rotation (C) of the thrust head (12b) intersects the direction of movement of the insert (11). In a 101st aspect, according to any one of the aspects from the 91st to the 100th, the lever (12a) is integral with the thrust head (12b).

In a 102nd aspect, according to any one of the preceding aspects, the block (10) comprises a guide (15) fixed to the support base (30) and configured to guide the movement of the insert (11) relatively to the shaft (31), optionally between the release position and the thrust one and vice versa.

In a 103rd aspect, according to the preceding aspect, the guide (15) is arranged at least partially in the at least an opening (33) passing through the support base (30). In an aspect, according to the 101st or 102nd aspect, the guide comprises a cylindrical bushing fixed to the support base (30) and housed in the through opening (33).

In a 104th aspect is provided an adjustment process of the wheel-holder (3) according to any one of the preceding aspects. In a 105th aspect, according to the preceding aspect, the adjustment process of the wheel-holder (3) comprises the following steps:
acting on the maneuvering element (12) to arrange said maneuvering element (12) in the release position,
exerting a thrust on the support plate (3b) or on the shaft (31) having a component along a relative sliding direction between support base (30) and shaft (31) suitable for counteracting the thrust generated by the at least one pusher (20) and allowing the disengagement of the head body (11a) from the stop (32) to allow the relative displacement of said shaft (31) with respect to the support base (30).

In a 106th aspect, according to the preceding aspect, the thrust action on the support plate (3b) or on the shaft (31) generates a thrust component having direction parallel to the extension trajectory (T) of the shaft.

In a 107th aspect, according to the 105th or 106th aspect, the thrust action on the support plate (3b) or on the shaft (31) allows to the shaft (31) to counteract the thrust of the pusher (20) to move at least the head body (11a) of the insert (11) to disengage said head body (11a) from the stop (32).

In a 108th aspect, according to any one of the preceding aspects, the process provides, as a result of the disengagement of the insert (11) with at least one stop (32), the movement of the shaft (31) relatively to the support base (30) to vary a distance between said support base (30) and the support plate (3b). In a 109th aspect, according to the preceding aspect, the process provides, as a result of the relative movement of the shaft (31) with respect to the support, the following steps:
aligning an additional stop (32) with the insert (11),
during the alignment of the additional stop with the insert, the pusher (20) acts on the head body (11a) to force the engagement of said head body with the additional stop to lock the relative movement between shaft and support base (30),
as a result of the engagement of the head body (11a) with the stop (32), acting on the maneuvering element (12) to define the thrust position where the thrust head (12b) of the maneuvering element (12) locks the insert against the shaft (31).

In a 110th aspect is provided a tire changer apparatus (1) for the mounting/demounting of a tire (P) from a rim of a wheel of a vehicle, said tire changer apparatus (1) comprising:
a base (2),
a wheel-holder (3) according to any one of the preceding aspects, said wheel-holder (3) being engaged to the base (2) and configured to rotate at least one wheel of a vehicle around an axis of rotation (Z).

In a 111th aspect, according to the preceding aspect, the tire changer apparatus (1) comprises also:
a frame (4) emerging from the base (2) along a direction substantially parallel to the axis of rotation (Z),
at least one tool (8) configured to operate on a rim and/or a tire of a wheel carried by the wheel-holder (3).

In a 112th aspect, according to the preceding aspect, the frame (4) comprises at least one first and second column (4a, 4b) emerging from the base along a direction substantially parallel to the axis of rotation (Z), wherein said first and second column (4a, 4b) are opposed the one to the other with respect to an ideal centerline plane (P) of the tire changer apparatus (1) parallel to the axis of rotation (Z).

In a 113th aspect, according to the preceding aspect, the tire changer apparatus (1) comprises: at least one first device (5) comprising:
at least an arm (7) carried by the first column (4a), wherein said arm (7) of the first device (5) extends between a front portion (7a) directed toward the axis of rotation (Z) and an opposed rear portion (7b),
at least one tool (8) terminally carried by the arm (7) in correspondence of the front portion (7a) and configured to operate on a rim and/or a tire of a wheel arranged on the wheel-holder (3),
at least one second device (6) comprising:
at least an arm (70) carried by the second column (4b), wherein said arm (70) of the second device (6) extends between a front portion (70a) directed toward the axis of rotation (Z) and an opposed rear portion (70b),
at least one tool (80) terminally carried by the arm (70) in correspondence of the front portion (70a) and configured to operate on a rim and/or a tire of a wheel carried by the wheel-holder (3), wherein said tool (80) of the second device (6) is opposed to the tool (8) of the first device (5) with respect to the ideal centerline plane (P) of the tire changer apparatus (1).

In a 114th aspect, according to any one of the aspects from the 110th to the 113th, the tire changer apparatus (1) comprises at least one lifting actuator active on at least one of said first and second device (5, 6), said lifting actuator being configured to allow the movement of at least one of said first and second device (5, 6) relatively to the base (2) along a direction substantially parallel to the axis of rotation (Z) of the wheel.

In a 115th aspect, according to the preceding aspect, the at least one lifting actuator comprises a first and a second lifting actuator distinct and respectively active in an independent manner on the first and second device (5, 6). In a 116th aspect, according to the preceding aspect, the first lifting actuator is configured to move the first device (5) along the first column (4a) approaching and away with respect to the base (2). In a 117th aspect, according to the 115th or 116th aspect, the second lifting actuator is configured to move the second device (6) along the second column (4b) approaching and away with respect to the base (2).

In a 118th aspect, according to any one of the aspects from the 110th to the 117th, the wheel mountable on the wheel-holder (3) is of the type comprising:
a rim comprising a central section configured to allow the mounting of the rim on the vehicle and a first and second perimeter edge opposed and configured to allow the engagement of a tire,
a tire comprising:
   a first bead configured to engage to the first perimeter edge of the rim,
   a second bead configured to engage to the second perimeter edge of the rim,
   a tread configured to define, in conditions of use on a vehicle, the contact element of the tire with the asphalt,
   a first side that connects the first bead to the tread,
   a second side that connects the second bead to the tread.

In a 119th aspect, according to the preceding aspect, the tool (8) of the first device (5) comprises a mounting-dismounting tool configured to radially interpose between the first perimeter edge of the rim and the first bead of the tire to allow the engagement-disengagement of said first bead with/from the first perimeter edge of the rim.

In a 120th aspect, according to the 118th or 119th aspect, the tool (80) of the second device (6) comprises a bead breaker tool configured to thrust on the first bead of the tire to allow at least a partial detachment of said first bead from the first perimeter edge of the rim. In a 121st aspect, according to the preceding aspect, the bead breaker tool comprises a rotating body configured to define with the tire a rolling type friction, the rotating body being configured to rotate around its own axis in an operating condition where the wheel rotates around the axis of rotation (Z) and the rotating body contacts the tire. In a 122nd aspect, according to the preceding aspect, the rotating body comprises at least one selected from among: a disk, a cylinder, a sphere.

In a 123rd aspect, according to any one of the aspects from the 110th to the 122nd, the extension trajectory (T) of the shaft (31) of the wheel-holder (3) is parallel to the axis of rotation (Z). In a 124th aspect, according to any one of the aspects from the 110th to the 123rd, the support base (30) of the wheel-holder is directly engaged to the base. In a 125th aspect, according to any one of the aspects from the 110th to the 124th, the support base (30) is engaged to the base in correspondence of the lower end (30′) of the support base (30). In a 126th aspect, according to any one of the aspects from the 110th to the 125th, the tire changer apparatus (1) comprises a motor connected to at least one of the support base (30) and the shaft, optionally to the lower end (30′) of the support base (30), and configured to put in rotation the wheel-holder (3) around the axis (Z). In a 127th aspect, according to the preceding aspect, the motor comprises an electric motor.

In a 128th aspect, according to the 126th or 127th aspect, the motor is housed internally to the base (2).

In a 129th aspect, according to any one of the preceding aspects, the wheel-holder (3) comprises a pin (3d) emerging from the support plate (3b) on the opposite side with respect to the shaft (31), the pin (3d) being configured to engage at least a portion of the rim to counteract a relative rotation between said rim and the support plate (3b). In a 130th aspect, according to the preceding aspect, the thrust (3d) is movable relatively to the support plate (3b) along a plane orthogonal to the axis of rotation (Z). In a 131st aspect, according to the preceding aspect, the thrust (3d) is adjustable in the position with respect to the axis of rotation (Z).

In a 132nd aspect, according to any one of the aspects from the 110th to the 131st, the base (2) extends between a front portion (2a) and a rear portion (2b). In a 133rd aspect, according to the preceding aspect, the frame (4) emerges from the base (2) in correspondence of the rear portion (2b) of said base (2). In a 134th aspect, according to any one of the two preceding aspects, the wheel-holder (3) emerges from the base (2) in correspondence of a portion interposed between the front portion and the rear portion of said base (2).

In a 135th aspect is provided a use of said wheel-holder (3) for the mounting/demounting of a tire from the rim of a wheel of a vehicle.

In a 136th aspect is provided a process of working a wheel of a vehicle having a tire associable to a rim through a tire changer apparatus (1) according to any one of the aspects from the 110th to the 135th. In a 137th aspect, according to the preceding aspect, the process comprises the following steps:
following the adjustment process according to any one of the aspects from 104th to 109th, bringing the support plate (3b) of the wheel-holder (3) at a desired height,
arranging a wheel in support on the wheel-holder (3),
locking the wheel to the wheel-holder (3),
rotating the wheel-holder (3), consequently the wheel, around the axis (Z),
contacting the wheel in rotation on the wheel-holder (3) by at least one tool of the tire changer apparatus (1) to allow the mounting/demounting of the tire from the rim.

### DESCRIPTION OF THE DRAWINGS

Some embodiments and aspects of the invention will be described below with reference to the attached figures, which are provided for illustrative purposes only and are therefore not limitative wherein:

FIG. 1 is a perspective view of a tire changer apparatus;

FIG. 2 is a perspective view of a first embodiment of a wheel-holder according to the present invention;

FIG. 3 is a sectional view, according to the Ill-Ill track, of the wheel-holder of FIG. 2;

FIG. 4 is a sectional view, according to the IV-IV track, of the wheel-holder of FIG. 2 wherein is shown a maneuvering element in a thrust position;

FIG. 4A is a further sectional view of the wheel-holder of FIG. 2 wherein it is shown the maneuvering element in a release position;

FIG. 5 is a perspective view of a second embodiment of a wheel-holder according to the present invention;

FIGS. 6 and 7 are further detailed perspective views of the wheel-holder of FIG. 5;

FIG. 8 is a sectional view, according to the VIII-VIII track, of the wheel-holder of FIG. 5;

FIG. 9 is a sectional view, according to the IX-IX track, of the wheel-holder of FIG. 5 wherein it is shown a maneuvering element in a thrust position;

FIG. 9A is a further sectional view of the wheel-holder of FIG. 5 wherein it is shown the maneuvering element in a release position; and

FIG. 10 is a sectional view of a wheel-holder according to a third embodiment.

### DEFINITIONS

It is noted that in the present detailed description, corresponding parts shown in the various FIGS. are indicated with the same numerical references. Figures may show the object of the invention by means of non-scaled representations; therefore, parts and components shown in FIGS. may only refer to schematic representations.

The terms “horizontal” or “vertical” used in connection with components of the tire changer apparatus, refer to a condition of use of the same during which the equipment performs, or is usable for the execution of, a process of mounting/demounting of a tire from a rim of a wheel.

The tire changer apparatus described and claimed herein may comprise/use at least one control unit in charge of the control of the operating conditions put in place by the same apparatus and/or to the control of the steps of the process of mounting/demounting of a tire from a rim of a wheel. The control unit may be a single unit or be formed by a plurality of distinct control units depending on design choices and operating requirements.

With ‘control unit’ is intended as an electronic type component which may comprise at least one among: a digital processor (CPU), an analogue type circuit, or a combination of one or more digital processors with one or more analogue type circuits. The control unit may be “configured” or “programmed” to perform certain steps: this may be realized in practice with any means that allow to configure or program the control unit. For example, in case of a control unit comprising one or more CPUs and one or more memories, one or more programs may be stored in appropriate memory banks connected to the CPU or CPUs; the program or programs contain instructions which, when performed by the CPU or CPUs, program or configure the control unit to perform the operations described in relation to the control unit. Alternatively, whether the control unit is or comprises analogue type circuitry, the circuit of the control unit may then be designed to include circuitry configured, in use, to process electrical signals so as to perform the steps relative to the control unit.

Parts of the process herein described may be realized through a data processing unit, or control unit, technically replaceable with one or more electronic processors designed to carry out a portion of a software program or firmware loaded onto a memory support. Such a software program may be written in any programming language of known type. The electronic processors, if two or more in number, may be connected through a data connection such that their computing power is shared in any manner whatsoever; the same electronic processors may even be installed in geographically different locations, thereby realizing a distributed computing environment through the above-mentioned data connection.

The data processing unit, or control unit, may be a general-purpose type processor configured to perform one or more parts of the process detected in the present disclosure through the software or firmware program, or be an ASIC or dedicated processor or an FPGA, specifically programmed to perform at least part of the operations of the process described herein.

The memory support may be non-transitory and may be internal or external to the processor, or control unit, or data processing unit, and may—specifically—be a memory geographically located remotely with respect to the electronic processor. The memory support may also be physically divided into multiple portions, or in the form of cloud, and the software or firmware program may be physically provided for portions stored on geographically separated memory portions.

With ‘actuator’ is intended any device capable of causing a movement on a body, e.g., upon command from the control unit (reception by the actuator of a command sent by the control unit). The actuator may be of the electric type (e.g., an electric motor), pneumatic, mechanical (e.g., a spring), oleodynamic or other types.

With ‘wheel’ is intended an assembly comprising a rim coupled to a tire. With ‘rim’ is intended a component suitable for supporting a tire and comprising a central section suitable for defining the zone of anchorage of the rim to the frame of a vehicle. The rim comprises externally a seat, extending radially outwards and axially delimited by a first and by a second perimeter edge: the tire is engaged at the seat.

With “tire” it is intended any cover element, e.g., multilayer, mountable at the seat of a rim of a vehicle. The tire comprises:
a first bead configured to engage to the first edge of the rim,
a second bead configured to engage to the second edge of the rim,
a tread configured to define the contact element of the tire with the ground,
a first side that connects the first bead to the tread,
a second side that connects the second bead to the tread,

The distance between the first or second bead from the tread essentially defines the height of the tire, while the distance between the first and the second side essentially defines the width of the tire, that substantially coincides with the width of the rim defined by the distance between the first and the above-described second edge.

### DETAILED DESCRIPTION

### Wheel-Holder

With “3” it has been overall indicated a wheel-holder for vehicle wheels, for example usable by a tire changer apparatus 1 for the mounting/demounting of tires from a rim of a wheel.

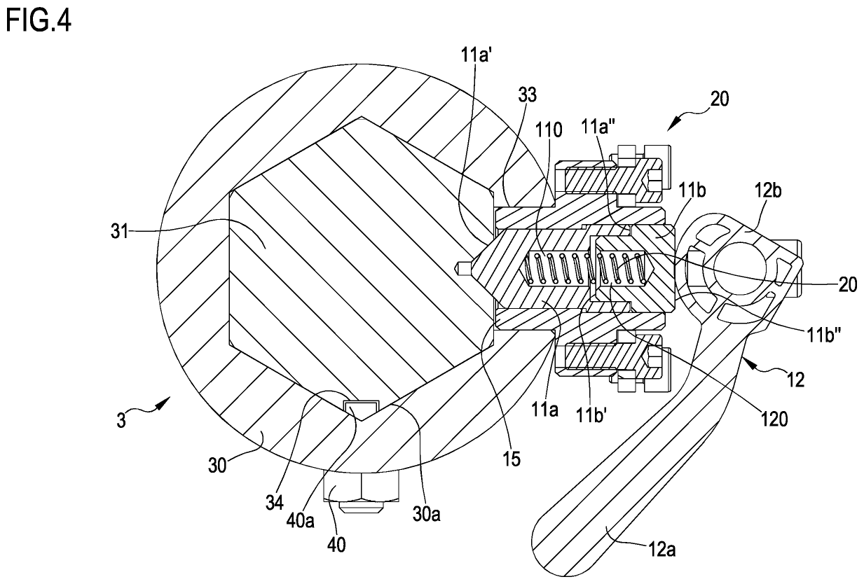

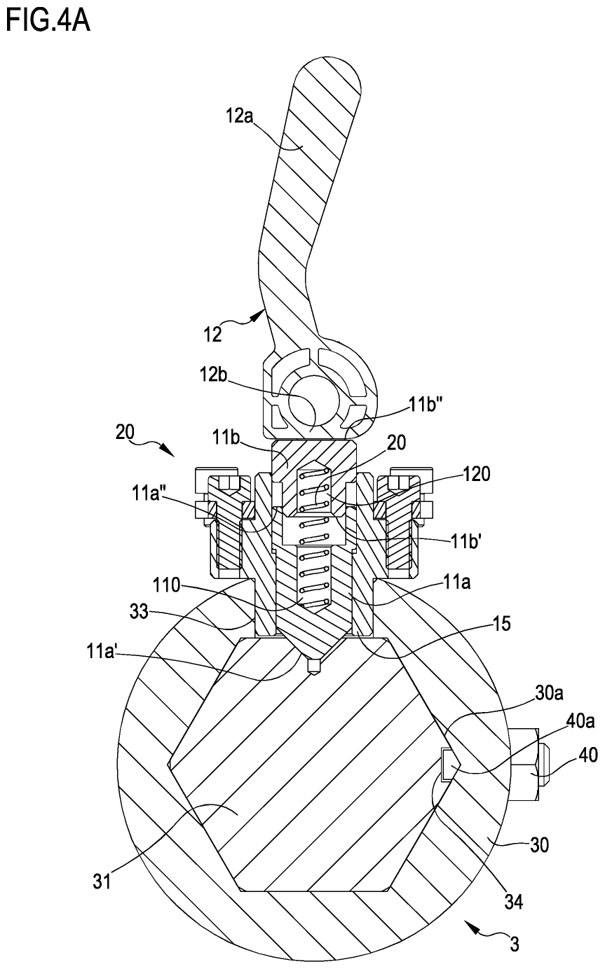

The wheel-holder 3 comprises a support base 30 engageable to a base 2 of a tire changer apparatus 1. The support base 30 comprises a seat 30a suitable for receiving in engagement a shaft 31 (described in detail below). The base body 30 extends between a lower end 30′ and an upper end 30″ along an extension direction A, for example straight. The seat 30a extends from the upper end 30″ to the lower end 30′ along the extension direction A; the seat 30a may be blind (i.e., ending at a closed bottom) or may be passing, i.e. extending along the whole development of the support base 30 (FIG. 4).

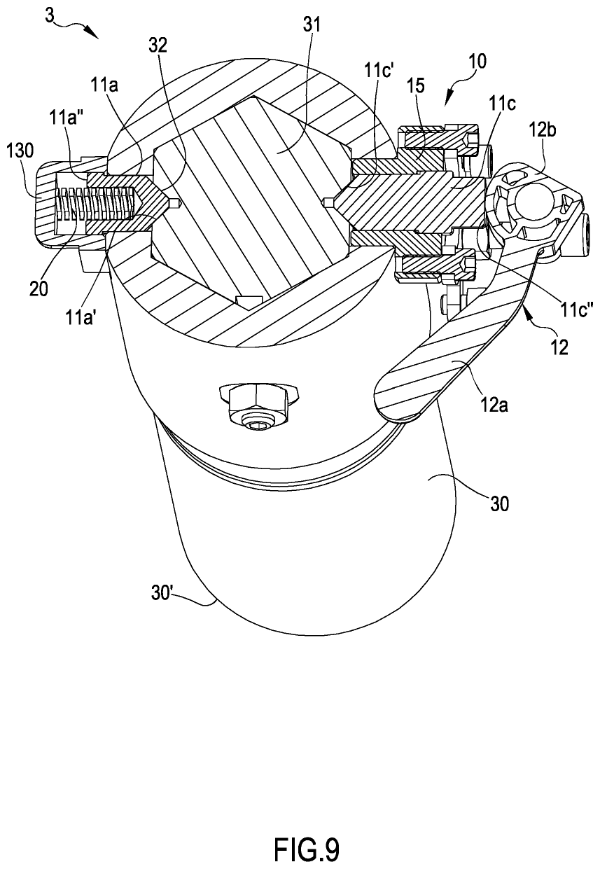

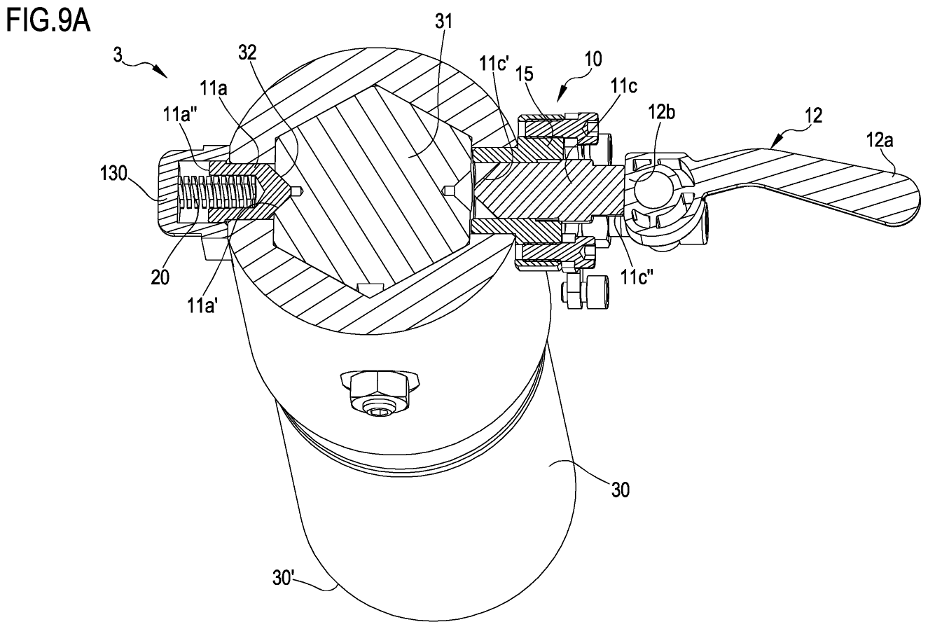

In detail, the support base 30 may comprise a lateral wall delimiting the seat 30; the outer surface of said lateral wall may have, according to a section orthogonal to the extension direction A, a shape circular while the inner surface of said lateral wall, delimiting the seat 30a, may have a different shape. For example, the seat 30a of the support base 30 may have, according to a section orthogonal to the extension direction A, a shape having at least two axes of symmetry. In particular, the seat 30a of the support base 30 may have, according to a section orthogonal to the extension direction A, a shape having a number of axes of symmetry higher than 1, optionally a number of axes of symmetry between 2 and 8. In FIGS. 4, 4A, 9 and 9A it is shown a seat 30a having, in a non-limiting way, a polygonal shape, optionally hexagonal; obviously it is not excluded the possibility to realize a seat 30a having circular shape or a seat having, according to a section orthogonal to the extension direction A, a shape having a number of axes of symmetry equal to 1 or higher than 8.

In fact, the support base 30 may be defined essentially by a hollow sleeve having an outer surface having a shape different from the shape of the inner surface delimiting the seat 30a; it is not excluded the possibility to realize a support base 30 whose inner and outer surfaces are identical in the shape (for example both circular or both polygonal).

Under the dimensional profile, the support base 30 may have a length between 100 mm and 500 mm, optionally between 250 mm and 400 mm; this length is defined by the maximum distance present between the lower end 30′ and the upper end 30″ (optionally along the extension direction A). The width of the support base 30 is instead measured along a plane orthogonal to the extension direction A of the support base itself; this width may be higher than 50 mm optionally between 60 mm and 200 mm, even more optionally between 60 mm and 120 mm.

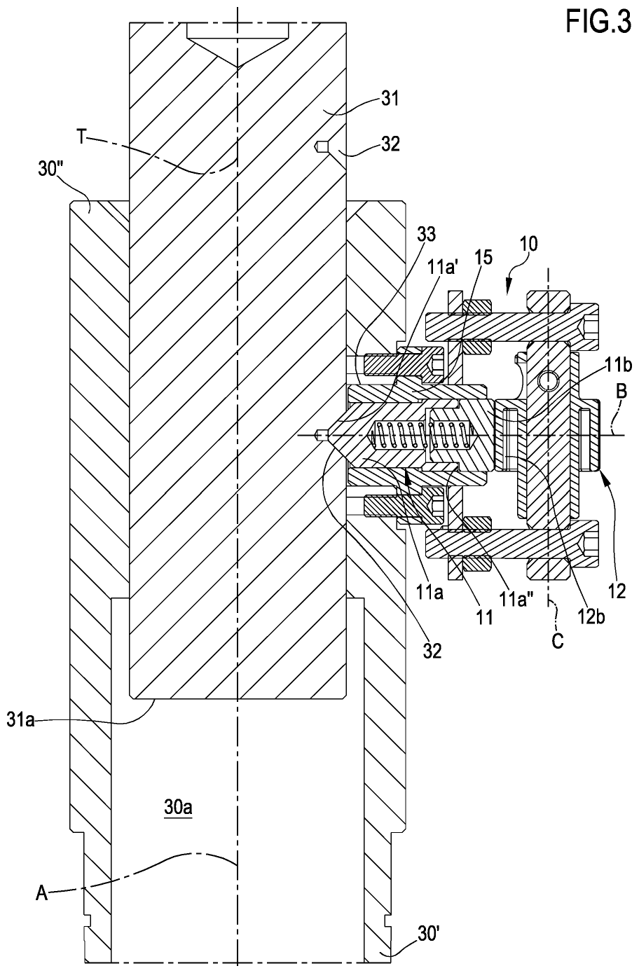

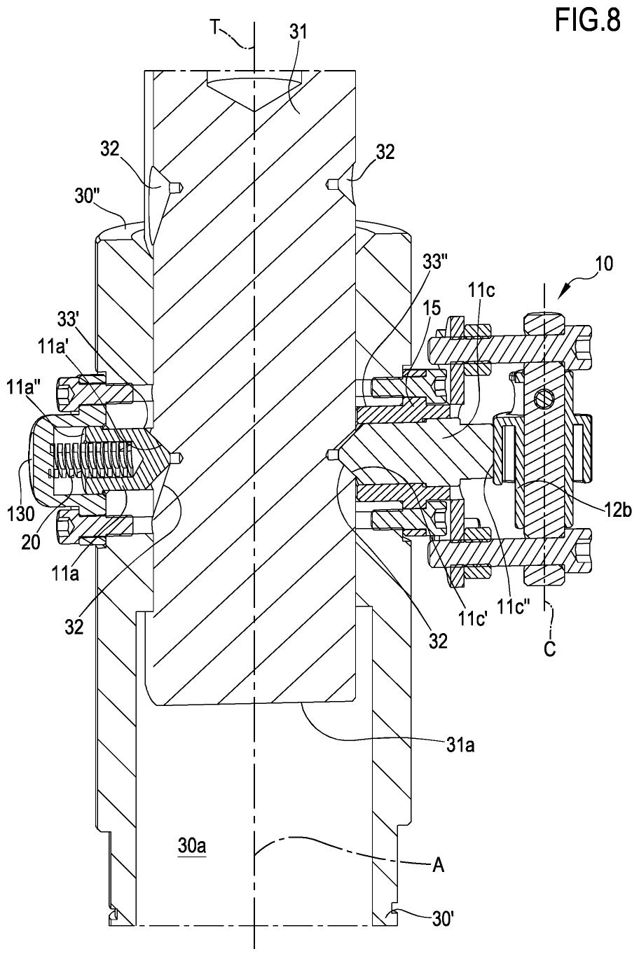

As visible from the FIGS. 3, 4, 7 and 9, the support base 30 may comprises at least an opening 33 through the lateral wall; in fact, this opening 33 puts in communication the seat 30a of the support base 30 with the outer environment to the support base 30. As visible for example in FIG. 3, the support base 30 may comprise an only through opening 33, for example placed at the upper end 30″ of the support base 30. The support base 30 may however comprise a plurality of through opening 33; for example, the support base 30 may comprise a first opening 33′ and a distinct second opening 33″ (FIGS. 8 and 9): said openings 33′, 33″ are distanced, optionally angularly offset with respect to an axis passing by the center support base 30 and extending parallel to the extension direction A. In a non-limiting way, a first and a second opening 33′, 33″ are opposed one to the other, with respect to a centerline plane of the support base 30. The first and the second opening 33′, 33′ may lie substantially on a same plane, orthogonal to the extension direction A of the support base 30 and may be both arranged at the upper end 30″ of the support base 30. The opening 33, optionally both the first and the second through opening, may comprise a hole, for example having circular section.

The wheel-holder 3 comprises also a shaft 31 housed at least partially in the seat 30a of the support base 30. The shaft is slidingly movable with respect to said support base 30 between a plurality of operating positions. The shaft 31 extends between a first and a second end 31a, 31b along an extension trajectory T, optionally straight: in the engagement condition between support base 30 and shaft 31, the extension trajectory T is parallel to the extension direction A of the support base 30.

The first end 31a of the shaft 31, in the various operating positions, is arranged in the seat 30a of the support base 30 while the second end 31b, in the various operating positions, is placed at different distances from the support base 30. In detail, the shaft 31 is movable with respect to the support base 30 at least between a first and a second operating position, wherein:
in the first operating position, the first end 31a of the shaft 31 is housed in the seat 30a of the support base 30 while the second end 31b is placed outside of said seat 30a at a first distance from said support base 30,
in the second operating position, the first end 31a of the shaft 31 is housed in the seat 30a of the support base 30 while the second end 31b is placed outside of said seat 30a at a second distance from said support base 30 greater than said first distance.

As visible from FIGS. 4, 4A, 9 and 9A, the shaft 31 is at least partially countershaped to the seat 30a. In detail, the shaft 31 has an outer surface, entirely countershaped to the seat 30a of the support base 30. The shaft 31 may then have, according to the section orthogonal to the extension trajectory T, a shape having a number of axes of symmetry higher than 1, optionally a number of axes of symmetry between 2 and 8. In FIGS. 4, 4A, 9 and 9A it is shown a shaft 31 having, in a non-limiting way, a polygonal shape, optionally in hexagonal shape; it is not excluded the possibility to realize a shaft 31 having circular shape or a shaft 31 having, according to the section orthogonal to the extension trajectory T, a shape having a number of axes of symmetry equal to 1 or higher than 8.

Thanks to the shape at least partially countershaped of the shaft 31 with respect to the seat 30a, the support base 30 may receive and guide in sliding the shaft 31 through the seat 30a between a plurality of operating positions. In fact, shaft 31 and support base 30 are constrained by a skid-type constraint: the shaft 31 is movable only slidingly relatively to the support base 30.

Under the dimensional profile, the shaft 31 may have a length between 100 mm and 500 mm, optionally between 250 mm and 400 mm; this length is defined by the maximum distance between the first end 31a and the second end 31b (optionally along the extension trajectory T). The width of the shaft 31 is instead measured along a plane orthogonal to the extension trajectory T of the shaft 31 itself; this width may be higher than 50 mm optionally between 60 mm and 200 mm, even more optionally between 60 mm and 120 mm.

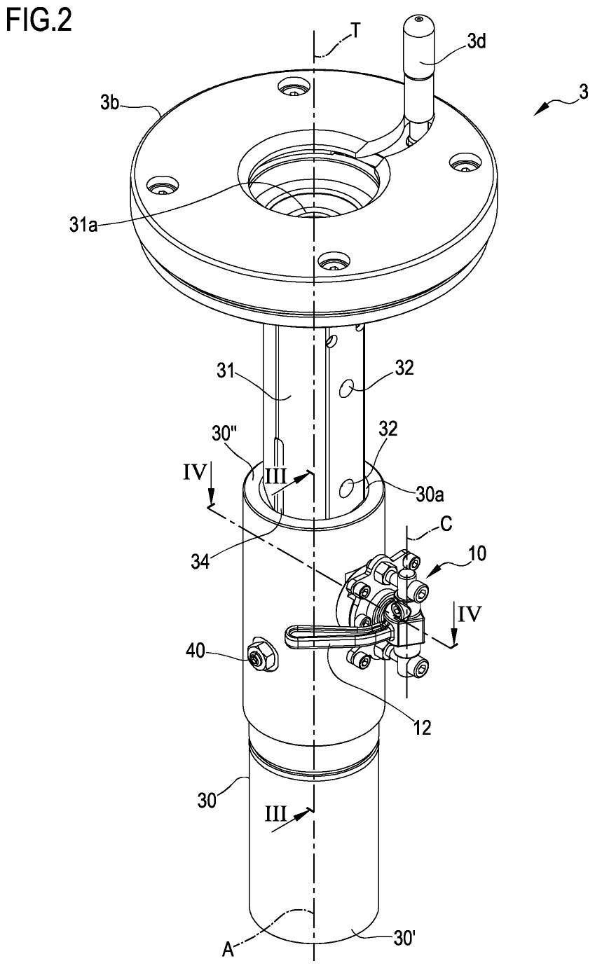

As visible from the attached figures, the shaft 31 comprises a plurality of stops 32 defined on an outer lateral surface of said shaft 31; the plurality of stops 32 may comprise at least one set of stops aligned along a direction substantially parallel to the extension trajectory T (see for example FIGS. 2 and 3). For example, the shaft 31 may have a number of stops 32 equal to or higher than 2, optionally between 3 and 12, even more optionally between 3 and 9; two stops 32 immediately consecutive and aligned along a direction parallel to the extension trajectory T of the shaft 31, may be placed at a distance from each other between 40 mm and 200 mm, optionally at a distance between 50 mm and 120 mm, even more optionally between 60 mm and 100 mm.

In FIG. 8, it is instead shown an embodiment shape of the shaft 31 wherein the plurality of stops 32 comprises:
a first set of stops aligned along a first direction substantially parallel to the extension trajectory T of the shaft itself,
a second set of stops spaced apart from the first set of stops and aligned along a second direction substantially parallel to the extension trajectory T of the shaft 31 itself.

The first and the second set of stops 32 are distinct and angularly offset with respect to a central axis of the shaft parallel to the extension trajectory T. In detail, the first and the second set of stops may be opposed, optionally may be the one symmetrical to the other with respect to a centerline plane of the shaft 31 (see for example FIG. 8).

The first set of stops may have a number of stops higher than 2, optionally between 2 and 5; the second set of stops has a number of stops higher than 2, optionally between 2 and 5.

The first and the second set of stops may be identical, i.e., have an identical number of stops 32 placed at a same distance from each other (the stops of the first set are laced at a distance from each other equal to a distance present between stops of the second set). The stops 32 of the first and second set of stops may also be identical, optionally equal in shape and size.

Each stop 32 may comprise a cavity, for example blind, which essentially defines, on the outer surface of the shaft 31, a recess. The cavity of each stop 32 may have, according to the section along a plane parallel to the extension trajectory T of the shaft and passing through a centerline of the stop 32, a substantially “V”-shaped outline, optionally may have a shape substantially straight circular or truncated cone shape.

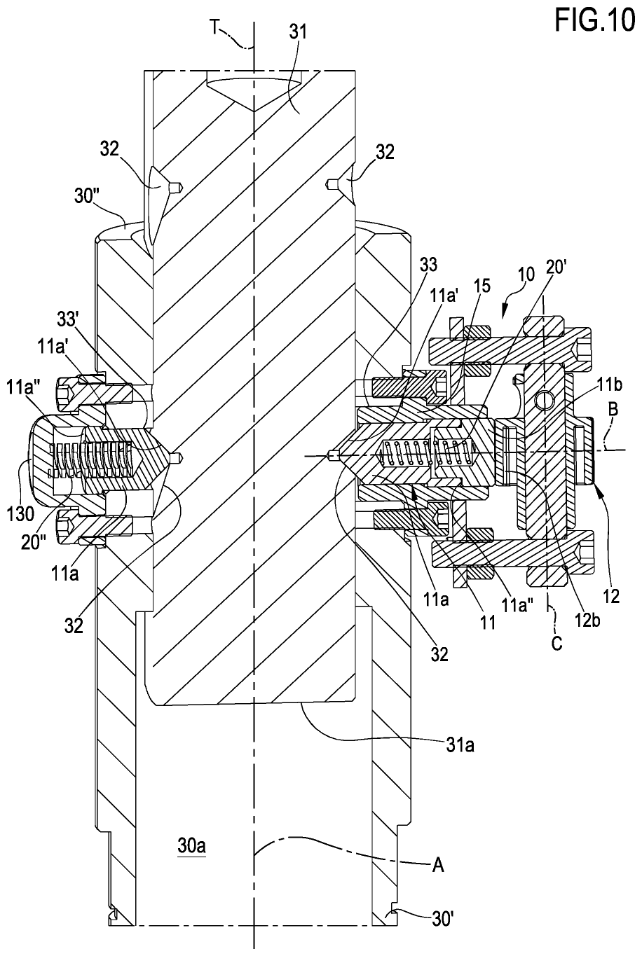

One or more stops 32, optionally all, may have a shape an oblique cone as, for example, shown in FIGS. 8 and 10. For example, the stops of the first set may have a shape substantially a straight circular cone while the stops of the second set may instead have an oblique cone shape. The oblique circular cone shape defines substantially, in section according to a plane parallel to the extension trajectory T of the shaft, a cavity having a substantially “V”-shaped outline, wherein
the upper tract, in use, of said “V” has a first inclination with respect to the extension trajectory T of the shaft 31,
the lower tract, in use, of said “V” has a second inclination with respect to the extension trajectory T of the shaft 31 lower with respect to the first inclination of the upper tract.

The difference in inclination between lower and upper tract of the cavity of the stops 32 allows the insert 11 to generate a different strength force on the shaft depending on the direction of movement of the shaft. In fact, the lower inclination of the lower tract allows the user, during an attempted extraction of the shaft 31 from the base body 30a by the user, to generate a thrust component on the pusher 20 greater than a thrust component generable by the user on the insert during a thrust attempt of the shaft 31 entering the base body 30a.

The wheel-holder 3 also comprises a support plate 3b carried by the shaft 31 and configured to receive a rim of a wheel. In detail, the support plate 3b is configured to directly constrain to an anchorage zone of the rim. The support plate 3b is fixed to the shaft 31 at the second end 31b of the shaft 31.

As mentioned, the shaft 31 is movable relatively to the support base 30, in a plurality of operating positions in which the second end 31b of the shaft 31 is placed at different distances from the support base 30; being the support plate 3b fixed to the second end of the shaft, also the support plate 3b, in the various operating positions of the shaft, it is positioned at different distances from the support base 30. The movement of the shaft 31 with respect to the support base 30 allows to adjust a height of the wheel-holder 3 and define a maximum extension of the shaft 31, defined essentially by the maximum distance present between the support plate 3b and the support base; this maximum extension may be higher than 70 mm, optionally between 80 mm and 300 mm, even more optionally between 90 mm and 250 mm.

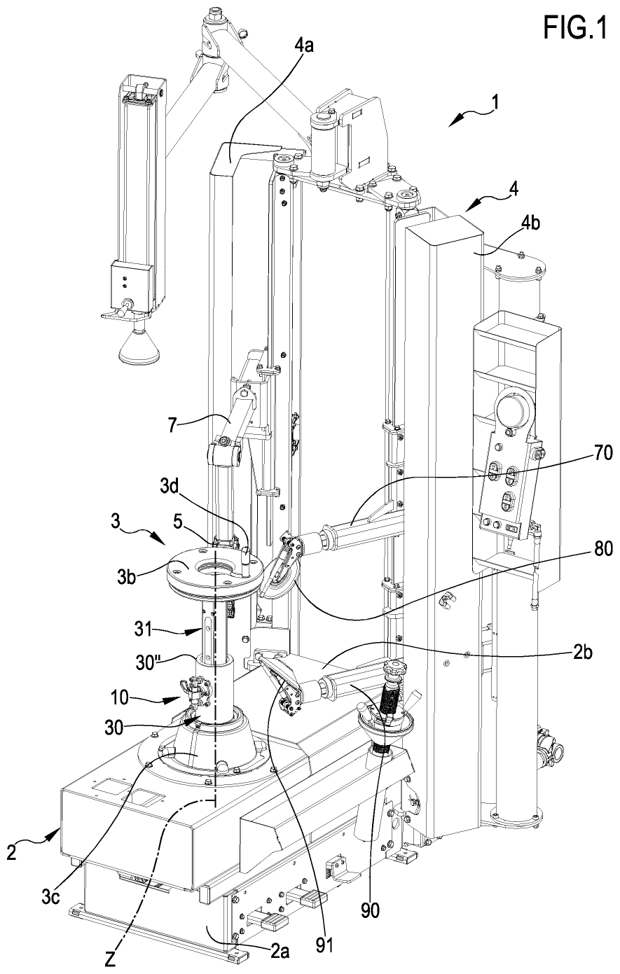

As visible from FIGS. 1, 2 and 5, the wheel-holder 3 may comprise also a pin 3d emerging from the support plate 3b on the opposite side with respect to the shaft 31; the pin 3d is configured to engage a portion of the rim of a wheel to counteract a relative rotation between said rim and the support plate 3b. The thrust 3d is radially offset with respect to a central axis of said shaft 31 and movable relatively to the support plate 3b along a plane orthogonal to said central axis in such a way that the radial position of the pin 3d is adjustable with respect to the position of the central axis; in this way, it is possible to adapt the position of the thrust 3d according to the size/shape of the rim to be engaged on the support plate 3b. In general, the pin 3d is moved with respect to the center axis to allow the insertion of it in a hole of the rim designed to receive the screws of the support plate of the vehicle on which the rim must be mounted.

As visible from FIG. 2, the support plate 3b has, at the center of it, a locking hole (the locking hole is placed concentrically to the central axis) configured to receive a pin configured to lock the rim on the wheel-holder 3. The pin may be of known type and comprise essentially a pin suitable for passing through the central section of the rim in support on the support plate 3b to engage the locking hole; on the opposite side of the pin, the pin comprises a truncated cone-shaped centering device configured to act on the central section of the rim to crush the latter on the support plate 3b and thus enabling the stable engagement of the wheel on the wheel-holder 3.

The wheel-holder 3 comprises also a block 10 carried by the support base 30 and configured to engage at least one stop 32 to lock the shaft 31 in an operative position, preventing the relative sliding between support base 30 and shaft 31. In detail, the block 10 is configured to lock the shaft 31 to the support base 30 as a result of the adjustment of the position in height of the shaft 31: the block 10 thus makes it essentially integral in the movement the shaft 31 and the support base 30. In greater detail still, the block 10 comprises at least an insert 11 movable with respect to the shaft 31 and a maneuvering element 12 active on the insert 11 and configurable between:
a thrust position where the maneuvering element 12 thrusts on at least a part of the insert 11 to allow it to be engaged with at least one stop 32 to lock the relative sliding between support base 30 and shaft 31,
a release position where the maneuvering element 12 is configured to allow the movement of the insert 11 with respect to the shaft 31.

The block 10 comprises also a pusher 20 (FIGS. 3, 4, 8 and 9) which, in the release position of the maneuvering element 12, thrusts on at least a part of said insert 11 to maintain said portion of the insert 11 in engagement with at least one stop 32 of the shaft 31.

The insert 11 is movable with respect to the support base 30 along a transversal direction, optionally orthogonal, to the extension trajectory T, approaching and away of the shaft 31, in particular approaching and away with respect to a central axis of the shaft 31. In detail, the insert 11 comprises a head body 11a which defines the part of the insert 11 suitable for cooperating with the stops 32 of the shaft. As visible from the FIGS. 3, 4, 8 and 9, the head body 11a extends between:
a front surface 11a′ configured to engage at least one stop 32 of the shaft 31,
a rear surface 11a″ opposed to the front surface 11a′ and configured to receive the pusher 20.

As visible from the attached figures, the front surface 11a′ is at least partially countershaped to the stops 32 of the shaft 31; in detail, the front surface 11a′ of the head body 11a may have, in section according to a plane parallel to the extension trajectory of the shaft 31, a substantially “V”-shaped outline, optionally may have a cone-shape or truncated cone-shape. It is not excluded the possibility of defining a front surface 11a′ of the head body 11a having only one surface inclined with respect to the extension trajectory T of the shaft 31; this inclination defines a portion inclined of the head body 11a suitable for contacting the stop 32 of the shaft 31 so that, in the release position of the maneuvering element 12 and following a thrust action on the shaft 31 having direction parallel to the extension trajectory T, the shaft 31 itself may generate a thrust force opposite to a thrust force generated by the pusher 20 that allows to the head body 11a to move relatively with respect to the support base 30, in particular away with respect to a central axis of the shaft 31. In other words, the surface inclined of the front surface 11a′ of the head body 11a in contact with the stop 32, in the release position of the maneuvering element 12 and during a thrust action by the user on the shaft 31, is configured to separate the component of force directed along the direction of movement of the shaft 31 (force directed along the extension trajectory T) to generate a component of force opposite to the thrust generated by the pusher 20; thus, when it is generated a thrust component opposite and greater than the thrust (thrust force) of the pusher 20, this thrust component allows to move the head body 11a relatively to the shaft 31, optionally away with respect to a central axis of said shaft 31.

The head body 11a may have a unique portion of front surface 11a′ inclined with respect to the extension trajectory T of the shaft or, as shown in the attached figures, may have two inclined portions (for example plan surfaces) with respect to the extension trajectory T essentially defining a front surface 11a′ having a substantially “V” shape; in this way, the shaft 31 is configured to generate a component opposite to the thrust of the pusher 20 during a bidirectional movement of the shaft 31, i.e. both during the approach and moving away of the second end 31b of the shaft to the support base 30.

In FIGS. 2-4A it is shown an insert 11 according to a first embodiment. This insert 11 comprises a bottom body 11b facing the head body 11a; the bottom body 11b is substantially aligned to the head body 11a along a direction B (FIG. 3) transversal, optionally orthogonal, to the extension trajectory T of the shaft 31. In this configuration (FIGS. 2-4A), the pusher 20 is interposed between the head body 11a and the bottom body 11b: the bottom body 11b directly contacts with the maneuvering element 12 which, in the release position and in the thrust position, directly contacts the bottom body 11b only.

In fact, the bottom body 11b is interposed between the head body 11a and the maneuvering element 12: on the one hand, the maneuvering element 12 acts directly on the bottom body 11b while, on the other hand, it is the pusher 20 which acts directly on said head body.

The pusher 20, interposed between head body 11a and bottom body 11b, is configured to normally keep said bodies 11a, 11b at a distance from each other so that the head body 11a may engage, also in the release position of the maneuvering element 12 at least one stop 32. The maneuvering element 12, in the thrust position is instead configured to win the thrust action of the pusher 20 to bring the bottom body 11b in contact with the head body 11a which, in this thrust position, results in forced contact with the stop 32. In the thrust position, the maneuvering element 12 prevents, even during a movement attempt of the shaft 31 along the extension trajectory T, to maintain the head body 11a steadily engaged with at least one stop 32, preventing any relative movement between shaft 31 and support base 30.

The head body 11a may have, at the rear surface 11a″, a blind seat 110 suitable for receiving the pusher 20; this seat 110 of the head body 11a extends from the rear surface 11a″ towards the front surface 11a′.

The seat 110 allows to receive and guide in position the pusher 20.

The bottom body 11b extends too respectively between:
a front surface 11b′ configured to directly contact the head body 11a of the insert 11,
a rear surface 11b″ opposed to the front surface 11b′ of the same bottom body 11b.

The rear surface 11b″ defines the part of the bottom body 11b which directly contacts the maneuvering element 12; the bottom body 11b may have, at the its front surface 11b′, a respective blind seat 120 suitable for receiving the pusher 20: the seat 120 of the bottom body 11b extends from the front surface 11b′ of the bottom body 11b, in direction of the rear surface 11b″ of the same bottom body 11b. The seat 120 of the bottom body 11b is facing the seat 110 of the head body 11a and configured to receive the pusher 20. In this configuration, the seat 110 of the head body 11a and the respective seat 120 of the bottom body 11b define substantially a single cavity where is housed the pusher 20.

Also the bottom body 11b may be at least partially housed in the seat 110 of the head body 11a so that the relative movement between head body 11a and bottom body 11b is guided along the direction B transversal to the extension trajectory T of the shaft 31. It is not excluded the possibility to realize a head body 11a housed in the seat 120 of the bottom body 11b.

As above described, the insert 11, in its first embodiment, has the head body 11a facing the bottom body 11b; in this first embodiment, the insert 11 is essentially defined by a single component placed on one side of the shaft 31; in this configuration, the head body 11a is configured to cooperate with a plurality of stops 32 aligned along a single direction parallel to the extension trajectory T of the shaft 31, optionally parallel to the extension trajectory T. In other words, the insert 11, in its first embodiment, may cooperate with a single set of stops 32 aligned along a single direction, parallel to the extension trajectory T.

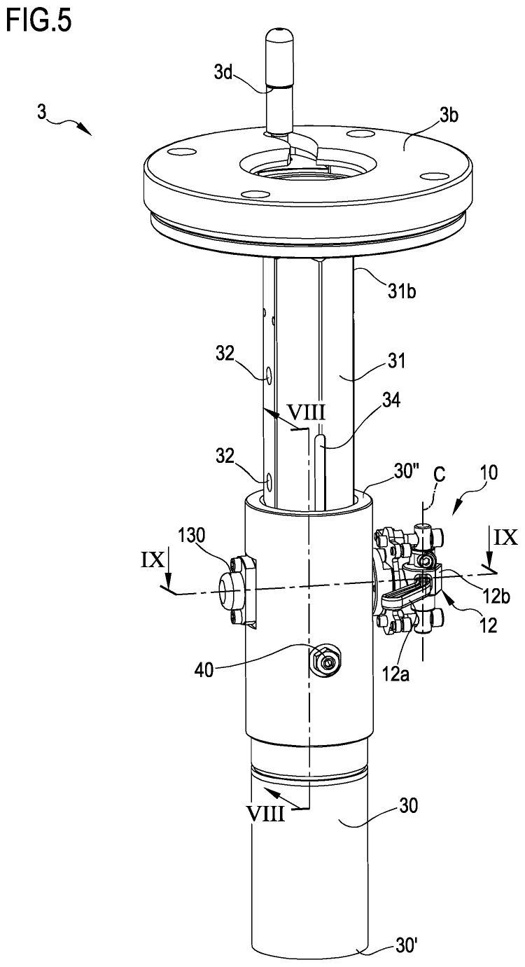

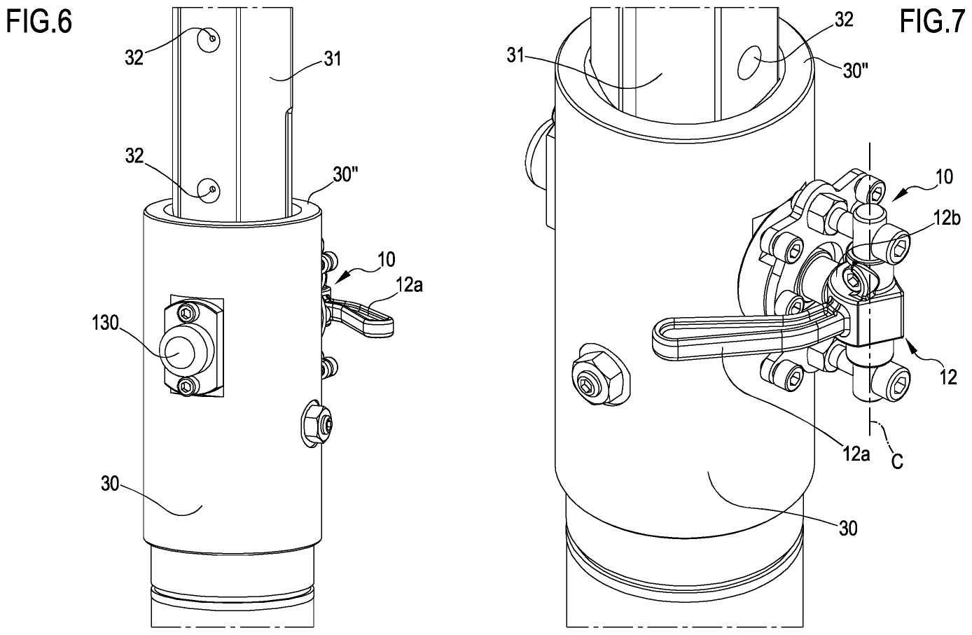

In FIGS. 5-9A it is shown an insert 11 according to a second embodiment. In the second embodiment, the insert 11 comprises the head body 11a according to the above description and an auxiliary body 11c distinct and spaced apart from the head body 11a. In the second embodiment, the pusher 20 acts only on the head body 11a; the block 10 comprises a support 130 engaged to the support base 30: the pusher 20 is interposed between the support 130 and the head body 11a to force the engagement of the head body 11a with at least one stop 32 of the shaft 31.

The auxiliary body 11c may be arranged substantially on a same plane upon which it is arranged the head body 11a: said plane is orthogonal to the extension trajectory T of the shaft 31. The auxiliary body 11c is angularly offset with respect to the head body 11a with respect to an axis parallel to the extension trajectory T of the shaft 31. In the attached FIGS. is shown, in a non-limiting way, an auxiliary body 11c opposed to the head body 11a with respect to the shaft 31; in this configuration, the head body 11a is configured to engage the stops of the first set of stops while the auxiliary body 11c is configured to engage the stops of the second set of stops 32.

In detail, the auxiliary body 11c extends between:
a front surface 11c′ configured to engage at least one stop 32 of the shaft 31,
a rear surface 11c″ opposed to said front surface 11c′ of the auxiliary body 11c and suitable for receiving in contact the maneuvering element 12.

The front surface 11c′ of the auxiliary body 11c is at least partially countershaped to the stops 32 of the shaft 31. In detail, the front surface 11c′ of the auxiliary body may have, in section according to a plane parallel to the extension trajectory of the shaft 31, a substantially “V”-shaped outline, a cone-shape or truncated cone-shape. In particular, the shaft 31 may have stops 32 having the same shape; in this configuration, the front surface 11a′ of the head body 11a and the front surface 11c′ of the auxiliary body 11c may be substantially identical in shape and size, suitable for engaging the stops 32 of the shaft 31.

In the second embodiment of the insert 11, the pusher 20 exclusively direct contacts the head body 11a while the maneuvering element 12 only directly thrusts on the auxiliary body 11c. The maneuvering element 12 is only active on the auxiliary body 11c of the insert 11 and configurable between:
a thrust position where the maneuvering element 12 only thrusts on said auxiliary body 11c to allow it to be engaged with at least one stop 32 to lock the relative sliding between support base 30 and shaft 31,
a release position where the maneuvering element 12 is configured to allow the movement of the auxiliary body 11c of the insert 11 away from the shaft 31, optionally away from the head body 11a.

Also in the second embodiment of the insert, the pusher 20, during the release position of the maneuvering element 12 during which the auxiliary body 11c is movable away of the shaft 31, thrusts on the head body 11a to force its engagement with a stop 32 of the shaft. The pusher, interposed between the support 130 and the rear surface 11a″ of the head body 11a is configured to maintain said head body in engagement with a stop 32 of the shaft, to counteract the relative movement between said shaft 31 and the support base 30.

On a functional level, the maneuvering element 12, in the thrust position, is configured to maintain the auxiliary body 11c in engagement with a stop 32 of the shaft 31, directly thrusting on the rear surface 11c″ of said auxiliary body (FIGS. 8, 9 and 9A); in this configuration, the auxiliary body 11c prevents the shaft 31, even upon user action, from generating on the head body 11a a thrust component suitable for winning the thrust action of the pusher 20 to move the head body 11a relatively to the shaft 31. After the movement of the maneuvering element 12 from the thrust position to the release one, the only axial constraint of the shaft 31 and defined by the head body 11a, kept in position by the pusher 20. In this configuration, as described above for the first embodiment of the insert 11, the head body 11a results movable with respect to the support base 30 as a result of a thrust action by the user on the shaft 31 suitable for generating a thrust component suitable for winning the thrust force generable by the pusher 20. In other words, the shaft 31 itself, upon user action, is configured to generate a thrust force opposite to a thrust force generated by the pusher 20 that allows to the head body 11a to move relatively with respect to the support base 30, in particular away with respect to a central axis of the shaft 31. As above mentioned, the inclined surface of the front surface 11a′ of the head body 11a in contact with the stop 32, in the release position of the maneuvering element 12 and during a thrust action by the user on the shaft 31, is configured to separate the component of force directed along the direction of movement of the shaft 31 (force directed along the extension trajectory T) to generate a component of force opposite to the thrust generated by the pusher 20; in this way, when it is generated a thrust component opposite and greater than the thrust (thrust force) of the pusher 20, this thrust component allows to move the head body 11a relatively to the shaft 31, optionally away with respect to a central axis of said shaft 31.

In FIG. 10 it is instead shown an insert according to a third embodiment. In fact, in its third embodiment the insert 11 has first head body 11a according to the head body 11a of the first embodiment of the insert which cooperates with the bottom body 11b always according to the first embodiment of the insert 11. In its third embodiment of the insert 11, the latter comprises a second head body 11a according to the head body according to the second embodiment of the insert 11.

In fact, in the third embodiment of the insert 11 are present:
a first pusher 20′ interposed between the first head body and the bottom body, and
a second pusher 20″ which is interposed between the second head body and the support 130.

The maneuvering element 12 only thrusts on the bottom body 11b. During the release position of the maneuvering element 12, the first and the second pusher 20′, 2″ force respective the first and second head body to remain in engagement with the shaft 31 to maintain said shaft 31 still in position with respect to the support base 30, at least until the operator thrusts on the shaft to move said insert 11.

As visible from the attached figures, the pusher 20 is directly in contact with the rear surface 11a″ of the head body 11a to force, in the release position of the maneuvering element 12, the engagement of the insert 11 with at least one stop 32 of the shaft 31: the pusher 20 is configured to maintain normally the head body 11a (optionally the first and second head body) in engagement with at least one stop 32 of the shaft 31. Thanks to the action of the pusher 20, it is possible to maintain still the shaft 31 with respect to the support base 30 also after the movement of the maneuvering element 12 in the release position; in this way, the user may substantially unlock, safely, the shaft 31 and only after having grasped the wheel-holder 3, thrusts on the shaft 31 to move it to the desired position.

The pusher 20 may comprise an elastic return element, for example a spring, optionally a compression spring. In the attached FIGS. is shown a pusher 20 comprising a compression spring but it is not excluded the possibility to use a different element configured to thrust on the head body 11a to maintain said head body 11a, in the release position of the maneuvering element 12. For example, the pusher 20 may comprise a torsional spring or a pneumatic actuator.

As above specified, the block 10 is engaged to the support base 30. The block 10 may be placed above the upper end 30″ or may be engaged to the lateral wall of said support base 30. In the attached FIGS. is shown, in a non-limiting way, a block 10 engaged to the lateral wall of the support base 30. In the configuration shown in the attached figures, the insert 11 is at least partially housed in a through opening 33 of the lateral wall of the support base 30 that puts in communication the seat 30a of the support base 30 with the outer environment to the wheel-holder 3.

In case wherein the wheel-holder 3 comprises an insert 11 according to the first embodiment, the support base 30 may comprise a unique through opening 33, arranged, in a non-limiting way, at the upper end 30″ of the support base. The head body 11a is housed at least partially in the opening 33 and is slidingly movable through said opening 33. The through opening 33 may be at least partially countershaped to the head body 11a to guide its sliding; alternatively, the block 10 may comprise a guide 15 fixed in the opening 33 of the support base 30 and configured to guide the movement of the insert 11 relatively to the shaft 31; in detail, the guide 15 may comprise a bushing fixed to the support base 30 and housed in the through opening 33; the outer surface of the bushing may be countershaped to the opening 33 of the support base 30 while the inner surface of the bushing, suitable for housing at least the head body 11a, may be at least partially countershaped to an outer lateral surface of said head body 11a. The bottom body 11b and the maneuvering element 12 are instead placed outside of said through opening 33.

In case wherein the wheel-holder 3 comprises an insert 11 according to the second embodiment, the support base 30 may comprise:
the first opening 33′ through the lateral wall inside which the head body 11a of the insert 11 is slidingly movable,
the second opening 33″ through the lateral wall inside which the auxiliary body 11c of the insert 11 is slidingly movable.

The first through opening 33′ may be arranged, in a non-limiting way, at the upper end 30″ of the support base 30. The head body 11a is housed at least partially in the first opening 33′ and is slidingly movable through the first opening 33′ relatively to the support base 30. The first opening 33′ may be at least partially countershaped to the head body 11a to guide its sliding; alternatively, the block 10 may comprise a guide 15 fixed to the support base 30, at least partially in the first opening 33′, and configured to guide the movement of the insert 11 relatively to the shaft 31; also in this configuration, the guide 15 may comprise a bushing fixed to the support base 30 and housed in the first opening 33′; the outer surface of the bushing may be countershaped to the first opening 33′ while the inner surface of the bushing, suitable for housing at least the head body 11a, may be at least partially countershaped to an outer lateral surface of the head body 11a.

Also the second through opening 33″ may be arranged, in a non-limiting way, at the upper end 30″ of the support base 30. The second opening 33″ is instead intended to house the auxiliary body 11c which is also slidingly movable through said second opening 33′ relatively to the support base 30, during the passage of the maneuvering element 12 from the thrust position to the release one, and vice versa. The second opening 33″ may be at least partially countershaped to the auxiliary body 11c to guide its sliding; alternatively, the block 10 may comprise a further guide 15 fixed to the support base 30, at least partially in the second opening 33″, and configured to guide the movement of the auxiliary body 11c relatively to the shaft 31; also in this configuration, the guide 15 may comprise a bushing fixed to the support base 30 and housed in the second opening 33″; the outer surface of the bushing may be countershaped to the second opening 33″ while the inner surface of the bushing may be at least partially countershaped to an outer lateral surface of the auxiliary body 11c.

In case wherein the wheel-holder 3 comprises an insert 11 according to the third embodiment, the support base 30 may comprise:
the first through opening 33′ according to the above description inside which the first head body 11a of the insert 11 is slidingly movable,
the second through opening 33″ according to the above description inside which the auxiliary body 11c of the insert 11 is slidingly movable.

The maneuvering element 12 may comprise a lever 12a that carries terminally a thrust head 12b: the thrust head 12b defines the part of the maneuvering element 12 suitable for directly thrusting on at least a part of the insert 11.

In FIGS. 2-4A it is shown the insert 11 according to the first embodiment; in this configuration, the thrust head 12b is placed directly in contact with the bottom body 11b (optionally with the rear surface 11b″): the thrust head 12b, in the thrust position of the maneuvering element 12, is configured to directly thrust on the bottom body 11b to allow the engagement of the head body 11a with at least one stop 32 of the shaft 31.

In FIGS. 5-9A it is shown instead the insert 11 according to the second embodiment; in this configuration, the thrust head 12b is placed directly in contact with the auxiliary body 11c: the thrust head 12b, in the thrust position of the maneuvering element 12, is configured to directly thrust on the auxiliary body 11c to allow it to be engaged with at least one stop 32 of the shaft 31.

The thrust head 12b may comprise an eccentric body integral to the lever 12a, configured to rotate relatively with respect to the insert 11; in detail, the thrust head 12b may comprises at least one cam. The thrust head 12b may rotate around an axis transversal to a direction of movement of the insert 11, for example around an axis C substantially parallel to the extension trajectory T of the shaft 31 (FIGS. 2, 3 and 8). It is not excluded the possibility to rotate the thrust head 12b (eccentric body) around a different axis, for example orthogonal to the extension trajectory T of the shaft 31. It is also not excluded the possibility to use a different maneuvering element 12, for example comprising at least one among: an electric motor, a pneumatic actuator, a hydraulic actuator.

The wheel-holder 3 may also comprise an end-stop 40 carried by the support base 30 and comprising for example a threaded screw, constrained in a threaded hole of the support base 30, through the lateral wall. An extremal portion 40a of the screw arranged in the seat 30a of the support base 30 is housed in a groove 34 obtained on the outer surface of the shaft 31 and extending parallel to the extension trajectory T of the shaft 31. The groove 34 extends between two ends whose distance defines the maximum axial movement of the shaft 31 between a lower end-stop position and an upper end-stop position; the screw 34 is configured to slide in the groove 40 during the relative movement of the shaft 31 with respect to the support base 30 and stop at an end to prevent the shaft 31 from moving beyond the lower and upper end-stop position.

In the attached FIGS. is shown a support base 30 engageable to a base of a tire changer and having a support plate carried by the shaft 31. It is obviously not excluded the possibility to provide a wheel-holder engageable to the base of a tire changer by means of the shaft 31, wherein the support plate is directly brought from the support base 30; also in this configuration, the relative movement between shaft 31 and support base 30 allows to move the support plate for adjusting the height of the wheel-holder 3.

### Adjustment Process

It is also an object of the present invention to provide an adjustment process of a wheel-holder 3 according to claim 1. The process comprises a step of acting on the maneuvering element 12 to arrange said maneuvering element 12 in the release position. This action may be performed by the user through a thrust action on the lever 12a; during this action, the thrust head 12b is rotated so that the head body 11a or the auxiliary body 11c of the insert 11 may move relative to the support base 30.

As a result of the action on the maneuvering element 12, the procedure may provide for a step of exerting a thrust on the support plate 3b or on the shaft 31 having a component along a relative sliding direction between support base 30 and shaft 31. As above specified, this thrust action exerted on the shaft allows to generate a thrust component (a force) suitable for counteracting the thrust generated by the pusher 20 (optionally of the first and second pusher 20′, 20″) to allow the disengagement of the head body 11a (optionally of the first and second head body) from the stop 32, to allow the relative movement of said shaft 31 with respect to the support base 30. Thanks to the configuration of the maneuvering element 12 in the release position and to the subsequent thrust exerted on the shaft 31 (directly on the shaft or on the support plate 3b) it is possible to move the head body 11a (optionally of the first and second head body) relative to the support base 30 for the disengagement with the stop 32.

In detail, the thrust action on the support plate 3b or on the shaft 31 generates a thrust component (force) having direction parallel to the extension trajectory T of the shaft 31; the shape incline of the insert 11 and/or of the stop 32 allows separation of the force directed along the extension trajectory T of the shaft 31 and to generate a parallel component but with direction opposite to the thrust force generatable by the pusher 20.

As a result of the disengagement of the head body 11a (optionally of the first and second head body) with the stop 32, the user may move the shaft 31 relatively to the support base 30 to vary a distance between said support base 30 and the support plate 3b; in this way, the user may adjust the position of the support plate 3b with respect to the support base 30, i.e., a height of the wheel-holder 3.

As a result of the disengagement of the insert 11 with the stop 32, the procedure may comprise the following steps:
aligning a further stop 32 with the insert 11, optionally with the head body 11a,
during the alignment of the further stop with the insert, the pusher 20 (optionally the first and second pusher) acts on the head body 11a (optionally of the first and second head body) to force the engagement of said head body 11a (optionally of the first and second head body) with the further stop to lock the relative movement between shaft 31 and support base 30,
as a result of the engagement of the head body 11a with the stop 32, acting on the maneuvering element 12 to define the thrust position where the thrust head 12b of the maneuvering element 12 locks the insert 11 against the shaft 31.

### Tire Changer Apparatus

With 1 is has been indicated overall a tire changer apparatus for the mounting and/or demounting of tires from a rim of a wheel.

As visible from the attached figures, the tire changer apparatus 1 comprises a base 2 defining the support element of the various parts of the apparatus 1 described below. The base 2 extends longitudinally between a front portion 2a and a rear portion 2b (FIG. 1).

The tire changer apparatus 1 comprises also the wheel-holder 3 according to claim 1 and according to the above-indicated description. The wheel-holder 3 is coupled to the base 2, arranged in interposition between the front portion 2a and the rear portion 2b of the base 2, optionally at the front portion 2a. The wheel-holder 3 is configured to receive and engage a wheel and allow its rotation around an axis of rotation Z (FIG. 1).

In detail, the support base 30 is engageable to the base 2 at the lower end 30′; the lower end 30′ of the support base 30 is housed in an inner volume defined by the base 2 while, a preponderant part of the wheel-holder 3 emerges from said base. As visible, a preponderant part of the support base 30 emerges from the base while the shaft 31 is entirely arranged outside of the inner volume of the base 2.

The support base 30 is motorized so that the shaft 31, support base 30 and support plate 3b may rotate around the axis Z. In particular, the lower end 30′ of the support base 30 is placed in the inner volume of the base 2 within which is present an actuator, for example an electric motor or in inverter, coupled to the support base 30; the actuator is configured to allow the rotation of the support base 30 (then of the shaft and of the support plate 3b) around the axis Z. This actuator may be manually activated by an operator or may be managed by a control unit; the control unit may be configured to control the inverter and/or the electric motor in order to control the rotation of the shaft 31. If the tire changer apparatus 1 is provided with control unit, this may be configured to: monitor the angular position of the shaft 31, control the speed of rotation of the shaft 31.

The support plate 3b is instead configured to directly constrain to a zone of anchorage of the rim and rotate integrally to the shaft 31 around an axis coincident with the axis of rotation Z. In the attached figures, the axis of rotation Z of the wheel extends, in conditions of use of the tire changer apparatus 1, along a substantially vertical direction; however, it is not excluded the possibility of arranging a wheel-holder 3 configured to put in rotation the wheel around a substantially horizontal axis Z or around an inclined axis, by an angle between 0° and 90°, with respect to a horizontal reference plane.

The wheel-holder 3 may also comprise also a guide body 3c in tubular shape, optionally with circular section; the guide body 3c may emerge from the base 2, parallel to the direction of rotation Z, and wrap at least partially the support base 30 so as to essentially define a carter suitable for enclosing and protecting at least partially the support base.

As above mentioned, it is not excluded the possibility to reverse the engagement between wheel-holder 3 and base 2, engaging the shaft 31 of the wheel-holder 3 directly to the base 2 from which emerges the support base 30 carrying the support plate.

As above mentioned, the wheel-holder 3 may comprise the pin 3d which is configured to engage at least a portion of the rim to counteract a relative rotation between said rim and the support plate 3b. The pin 3d is radially offset with respect to the axis of rotation Z and movable relatively to the support plate 3b along a plane orthogonal to said axis of rotation Z so that the radial position of the pin 3d is adjustable with respect to the position of the axis of rotation Z; in this way, it is possible to adapt the position of the thrust 3d as a function of the size/shape of the rim to be engaged on the support plate 3b. In general, the pin 3d is moved with respect to the axis of rotation Z to allow the insertion of it within a hole of the rim dedicated to receive the screws of the fixing plate of the vehicle on which the rim is to be mounted.

As described above, the wheel-holder 3 is adjustable in height, i.e., it allows the movement of the shaft 31 and of the support plate 3b along a direction parallel to the axis of rotation Z. In fact, the shaft 31 allows to move the support plate 3b relatively to the base 2 so thatthe support plate 3b is adjustable in height. In this way, the user may position the support plate 3b, in as afunction of the size of the wheel, at a desired height. The guide body 3c is instead fixed to the base 2 so as to prevent relative movements of the wheel-holder 3 with respect to the base 2 according to plane orthogonal to the axis of rotation Z. In fact, the relative movements of the wheel-holder 3 with respect to the base 2 are:
the relative rotation of the shaft 31, consequently of the support plate 3b and of the pin 3d, around the axis of rotation Z,
the movement of the shaft 31, consequently of the support plate 3b and of the pin 3d, along a direction parallel to the axis of rotation Z.

In variant embodiment, the whole wheel-holder 3 may further move along a plane orthogonal to the axis Z, approaching and away from the rear portion 2b of the base 2.

The tire changer apparatus 1 may also comprise a frame 4 too emerging from the base 2 substantially at the rear portion 2b (FIG. 1) of the base. The frame 4 is fixed to the base 2 in a distal position with respect to the wheel-holder 3. The frame 4 extends mainly along a direction substantially parallel to the axis of rotation Z. In FIG. 1 it is shown a frame 4 extending, in a non-limiting way, along a vertical direction. In detail, the frame 4 extends between a bottom portion placed at the base 2 and a top portion opposed to the bottom portion.

The frame 4 supports at least one first and a second device 5, 6 (see for example FIG. 1) configured to operate on a rim and/or on a tire to allow the mounting and/or demounting of the latter on/from said rim. The frame 4 may comprise a first and a second column 4a, 4b emerging from the base 2 along a direction parallel to the axis of rotation Z; the first and the second column 4a, 4b may be arranged in contrast the one to the other with respect to an ideal centerline plane of the tire changer apparatus 1, parallel to the axis of rotation Z. The ideal centerline plane may be substantially vertical and extend also along a connection direction of the front portion 2a with the rear portion 2b of the base 2. The ideal centerline plane may be, in a non-limiting way, passing through the axis of rotation Z; it is obviously not excluded the possibility to provide a wheel-holder 3 offset with respect to the ideal centerline plane (in this configuration the ideal centerline plane does not embed the axis of rotation Z of the wheel-holder 3). It is not excluded the possibility to provide a tire changer apparatus 1 wherein the ideal centerline plane results substantially horizontal or inclined by an angle between 0° and 90°, with respect to a horizontal reference plane.

The first device 5 comprises at least an arm 7 carried by the first column 4a and extending between a front portion 7a directed toward the axis of rotation Z and an opposed rear portion 7b; the arm 7 of the first device 5 may be of fixed type (i.e. having a length prefixed, not variable) or may be of extensible type i.e. configured to move at least said front portion 7a relatively to the wheel-holder 3 to vary a distance between said front portion 7a of the arm 7 of the first device 5 and the axis of rotation Z. The arm 7, at the front portion 7a, carries at least one tool 8 which is configured to operate on a rim and/or a tire of a wheel carried by the wheel-holder 3.

If the arm 7 of the first device 5 is of extensible type the tool 8 results movable between a backward position and an advanced position with respect to the axis Z; the tool 8 of the first device 5, in the backward position, has a distance from the axis of rotation Z higher than a distance present between said axis of rotation Z and said tool 8 when arranged in the advanced position.

As visible for example from FIG. 1, the arm 7 of the first device 5 extends, in a non-limiting way, along a substantially straight development direction lying on a plane substantially orthogonal to the axis of rotation Z; it is not excluded the possibility to realize an arm 7 having different shape and size. If the arm 7 extends along a straight direction it is also possible to define an angle of inclination of said development direction with the ideal centerline plane to essentially define the inclination of the arm 7 with respect to said ideal centerline plane. The development direction of the arm 7 of the first device 5 is inclined with respect to the ideal centerline plane by an angle between 100 and 30°, even more optionally between 15° and 25°. This inclination may be fixed or adjustable.

The second device 6 comprises a respective arm 70 carried by the second column 4b and extending between a front portion 70a directed toward the axis of rotation Z and an opposed rear portion 70b; the arm 70 of the second device 6 may be fixed, i.e. having a length prefixed (not variable) or may be of extensible type i.e. configured to move at least said front portion 70a relatively to the wheel-holder 3 to vary a distance between said front portion 70a of the arm 70 of the second device 6 and the axis of rotation Z. The arm 70, at the front portion 70a, carries at least one tool 80 configured to operate on a rim and/or a tire of a wheel carried by the wheel-holder 3.

If the arm 70 of the second device 6 is of extensible type the tool 80 results movable approaching and away from the axis of rotation Z so as to move the tool 80 of said second device 6 at least between a backward position and an advanced position; the tool 80 of the second device 6, in the backward position, has a distance from the axis of rotation Z higher than a distance present between said axis of rotation Z and said tool 80 when arranged in the advanced position. In particular, the tool 80 of the second device 6, in the backward position, has a distance from the ideal centerline plane higher than a distance present between said ideal centerline plane and said tool 80 of the second device 6 when arranged in the advanced position. As mentioned above, the first and second device 5, 6 are opposed to each other with respect to the ideal centerline plane; therefore, also arms 7, 70 and tools 8, 80 of said devices are opposed with respect to said ideal centerline plane.

The arm 70 of the second device 6 extends, in a non-limiting way, along a substantially straight development direction lying on a plane substantially orthogonal to the axis of rotation Z; it is not excluded the possibility to realize an arm 70 having different shape and size. If the arm 70 extends along a straight direction it is also possible to define an angle of inclination of said development direction with the ideal centerline plane to essentially define the inclination of the arm 70 with respect to said ideal centerline plane. The development direction of the arm 70 of the second device 6 is inclined with respect to the ideal centerline plane by an angle between 10° and 30°, even more optionally between 15° and 25°. This inclination may be fixed or adjustable.

In detail, the inclinations of arms 7, 70 may be substantially identical so that the arms 7, 70 are substantially symmetrical with respect to the ideal centerline plane. In other words, the angle of inclination of the development direction of the arm 7 of the first device 5 with respect to the ideal centerline plane is substantially equal to the angle of inclination of the development direction of the arm 70 of the second device 6 with respect to said ideal centerline plane. The arm 70 of the second device 6 may have, in a non-limiting way, a structure similar to the one of the arms 7 of the first device 5.

In fact, both the arms 7, 70 of the first and second device 5, 6 may be of extensible type and thus capable of varying its distance with respect to the axis of rotation Z. Thanks to the extensibility of the arms 7, 70, the tire changer apparatus 1 allows to move the tools 8, 80 from a rest position, where said tools are not configured to operate on a wheel, to a work position, wherein said tools are configured to perform the operations of mounting/demounting of the tire from a rim of a wheel. Thanks to the extensibility of the arms 7, 70, the tire changer apparatus 1 is also capable of adapting the position of the tools 8, 80 as a function of the size of the wheel mounted on the wheel-holder 3.

The first and the second device 5, 6 may comprise respective carriages configured to slide along the respective columns to allow the movement of arms 7, 70 approaching and away with respect to the support plate 3b. This movement may be controlled by an actuator (for example pneumatic cylinder or a hydraulic cylinder). Each actuator may be controlled through a control unit.

The tools of the first and of the second device 5, 6 may be equal or have a different structure and function. In the attached FIGS. it is shown, in a non-limiting way, a tool 8 of the first device 5 comprising a mounting-dismounting tool configured to radially interpose between the first perimeter edge of the rim and the first bead of the tire to allow the engagement-disengagement of said first bead from the first perimeter edge of the rim.

The tool 80 of the second device 6 may comprise then a mounting-dismounting tool similar to the one of the first device 5 or may comprise, as shown in FIG. 1, a pressing element configured to thrust on the first bead of the tire to allow at least a partial detachment of said first bead from the first perimeter edge of the rim. The pressing element comprises a rotating body configured to define with the tire a rolling type friction; the rotating body is configured to rotate around its own axis in an operating condition where the wheel rotates around the axis of rotation Z and the rotating body contacts the tire. The rotating body comprises at least one selected among: a disk, a cylinder, a sphere.

As visible for example from FIG. 1, the tire changer apparatus may also comprise a third device 90 whose structure is similar to the one of the second device 6; in fact, the third device 90 is defined by a further pressing element placed, in conditions of use of the apparatus, under the second device 6 and capable of acting on the second bead of the tire to allow at least a partial detachment of said second bead from the second perimeter edge of the rim. The third device may be too movable along the second column 4b thanks to a carriage, independent in the movement to the carriage of the first and second device 5, 6.

In detail, the tire changer apparatus 1 according to the present invention may comprise a first and second device respectively according to the description of the first and second device of the tire changer apparatus of the patent application num. EP 4 067 121 A1, described in paragraphs [0114]-[0177]. Alternatively, the tire changer apparatus 1 according to the present invention may comprise a first and second device respectively according to the description of the first and second device of the tire changer apparatus of the patent application num. EP 3 865 321 A1, described in paragraphs [0110]-[0140].

The tire changer apparatus 1 according to the present invention may further comprise a third device according to the description of the third device of the tire changer apparatus of the patent application num.

EP 4 067 121 A1, described in paragraphs [0178]-[0202]. Alternatively, the tire changer apparatus 1 according to the present invention may further comprise a third device according to the description of the third device of the tire changer apparatus of the patent application num. EP 3 865 321 A1, described in paragraphs [0141]-[0149].

I/We claim:

1. A wheel-holder for a wheel of a vehicle, said wheel-holder comprising:
a support base having a seat,
a shaft housed at least partially in the seat, wherein the shaft is slidingly movable with respect to the support base between a plurality of operating positions, wherein the shaft comprises a plurality of stops defined on an outer lateral surface of said shaft,
a support plate configured to receive a rim of a wheel, wherein the support plate is carried by at least one of the shaft and the support base,
a block carried by the support base and configured to engage at least one stop for locking the shaft in an operating position, preventing the relative sliding between the support base and the shaft, wherein the block comprises:
at least one insert movable approaching and away with respect to the shaft,
a maneuvering element active on the insert and configurable between:
a thrust position where the maneuvering element thrusts on at least a part of the insert to allow it to be engaged with at least one stop and lock the relative sliding between support base and shaft,
a release position where the maneuvering element is configured to allow the insert to move away from the shaft,
characterized by the fact that the block comprises at least one pusher which, in the release position of the maneuvering element, thrusts on at least a part of said insert to maintain said part in engagement with at least one stop of the shaft.

2. The wheel-holder according to claim 1, wherein the shaft extends between a first and a second end along an extension trajectory, wherein the insert is movable with respect to the support base along a direction transversal to the extension trajectory.

3. The wheel-holder according to claim 1, wherein the insert comprises at least one head body that extends between:
a front surface configured to engage at least one stop of the shaft,
a rear surface opposed to the front surface, wherein the insert is configured to receive the pusher at the rear surface,
wherein the pusher direct contacts the rear surface of the head body to force, in the release position of the maneuvering element, the engagement of the insert with at least one stop of the shaft.

4. The wheel-holder according to claim 3, wherein the front surface is at least partially countershaped to the stops of the shaft.

5. The wheel-holder according to claim 3, wherein the front surface of the head body has a cone-shape or truncated cone-shape.

6. The wheel-holder according to claim 3, wherein the front surface of the insert has at least one contact portion configured to engage the stop and which is inclined with respect to the extension trajectory of the shaft, wherein said inclined contact portion of the front surface is configured to generate, at least in the release position of the maneuvering element and following a thrust action on the shaft having direction parallel to the extension trajectory, a thrust force opposite to a thrust force generated by the pusher.

7. The wheel-holder according to claim 3, wherein the head body has, at the rear surface, a blind seat suitable for receiving the pusher, wherein the seat of the head body extends from the rear surface towards the front surface.

8. The wheel-holder according to claim 3, wherein the insert comprises a bottom body facing the head body, wherein the pusher is interposed between the head body and the bottom body.

9. The wheel-holder according to claim 8, wherein the maneuvering element, in the release position and in the thrust position, directly contacts the bottom body.

10. The wheel-holder according to claim 8, wherein the bottom body extends between:
a front surface configured to directly contact the head body of the insert,
a rear surface opposed to the front surface of said bottom body,
wherein the rear surface of the bottom body directly contacts the maneuvering element.

11. The wheel-holder according to claim 10, wherein the bottom body has, at its front surface, a respective blind seat suitable for receiving the pusher.

12. The wheel-holder according to claim 11, wherein the seat of the bottom body faces the respective seat of the head body.

13. The wheel-holder according to claim 11, wherein the seat of the head body and the respective seat of the bottom body define a single cavity where the pusher is housed.

14. The wheel-holder according to claim 8, wherein the bottom body directly contacts the maneuvering element, wherein the bottom body is interposed between the head body and the maneuvering element.

15. The wheel-holder according to claim 8, wherein the bottom body is at least partially housed and slidingly movable in the seat of the head body.

16. The wheel-holder according to claim 3, wherein the insert comprises an auxiliary body distinct and spaced apart from the head body, wherein the auxiliary body is opposed to the head body with respect to the shaft,
wherein the pusher directly contacts the head body of the insert whereas the maneuvering element directly thrusts on the auxiliary body.

17. The wheel-holder according to claim 16, wherein the plurality of stops comprises:
a first set of stops aligned along a first direction substantially parallel to the extension trajectory of the shaft itself,
a second set of stops opposed to the first set of stops and aligned along a second direction substantially parallel to the extension trajectory of the shaft itself,
wherein the head body is configured to engage the stops of the first set of stops whereas the auxiliary body is configured to engage the stops of the second set of stops.

18. The wheel-holder according to claim 1, wherein the plurality of stops comprises at least one set of stops aligned along a direction substantially parallel to the extension trajectory of the shaft itself.

19. The wheel-holder according to claim 1, wherein the shaft has at least 2 stops.

20. The wheel-holder according to claim 1, wherein the shaft has a number of stops between 3 and 12, inclusive.
